(19) United States
(12) Patent Application Publication
(10) Pub. No.: US 2016/0142407 A1
(43) Pub. Date: May 19, 2016

(54) METHOD AND APPARATUS FOR DISPLAYING USER INTERFACE IN ELECTRONIC DEVICE

(71) Applicant: Samsung Electronics Co., Ltd., Suwon-si (KR)

(72) Inventors: Jae-Woong CHUN, Suwon-si (KR); Su-Young PARK, Uiwang-si (KR); Cheol-Ho CHEONG, Seoul (KR)

(21) Appl. No.: 14/934,846

(22) Filed: Nov. 6, 2015

(30) Foreign Application Priority Data
Nov. 14, 2014 (KR) 10-2014-0158948

(51) Int. Cl. H04L 29/06; G06F 9/54

(52) U.S. Cl. CPC H04L 63/0861; H04L 63/12; G06F 9/542

(57) ABSTRACT

A method for obtaining biometric information associated with a user of the electronic device from the electronic device is provided. The method includes determining condition information associated with the user based on at least the biometric information, displaying a notification corresponding to the biometric information via a display functionally connected to the electronic device when the condition information corresponds to a first predefined condition, and automatically executing an application associated with the biometric information when the condition information corresponds to a second predefined condition. Other embodiments are also possible.

### CROSS-REFERENCE TO RELATED APPLICATION(S)

This application claims the benefit under 35 U.S.C. §119(a) of a Korean patent application filed on Nov. 14, 2014 in the Korean Intellectual Property Office and assigned Serial No. 10-2014-0158948, the entire disclosure of which is hereby incorporated by reference.

### TECHNICAL FIELD

The present disclosure relates to a method and apparatus for displaying a user interface in an electronic device.

### BACKGROUND

With the development of mobile communication technologies, an electronic device may perform a variety of data communication functions as well as a voice call function. The electronic device, for example, a mobile device or a user equipment (UE) may provide various services through various applications. The electronic device may provide multimedia services, for example, network-based communication services, such as music services, video services, digital broadcast services, etc., or network-based communication services such as calls, wireless Internet, short messaging services (SMSs), multimedia messaging services (MMSs), etc. In addition, the electronic device may acquire sensor information through a variety of sensor modules mounted in the electronic device. The electronic device may include a sensor module, for example, an acceleration sensor, a gyro sensor, a red, green, and blue (RGB) sensor, or an illumination sensor.

The above information is presented as background information only to assist with an understanding of the present disclosure. No determination has been made, and no assertion is made, as to whether any of the above might be applicable as prior art with regard to the present disclosure.

### SUMMARY

The variety of sensor modules capable of measuring the status of a user are mounted in the electronic device, by which it is possible to measure user-related information and provide the measured information to the user. For example, the electronic device may include an application that measures the status of the user (e.g., a heart rate, the number of steps, a momentum, calorie information, etc.) by utilizing the sensor modules functionally connected to the electronic device and provides value information associated with the measured status of the user.

In order to provide the status of the user, the electronic device is required to recognize a user's input (e.g., touch) or an application installed in the electronic device is required to be driven, and therefore there may be difficulties in efficiently providing the status of the user. For example, in order to acquire information associated with the status of the user from the electronic device, the application must be driven through the user's input or must be driven in the electronic device, and therefore the user cannot easily determine desired individual information and there may be difficulties in efficiently using services provided by the electronic device.

Aspects of the present disclosure are to address at least the above-mentioned problems and/or disadvantages and to provide at least the advantages described below. Accordingly, an aspect of the present disclosure is to provide an apparatus and method for displaying a user interface in an electronic device (e.g., a mobile terminal) based on information exchanged between the electronic device and sensor modules (e.g., a pulse sensor, an acceleration sensor, etc.) provided in the electronic device, and an electronic device thereof. In addition, according to various embodiments, there is provided a method for changing a user interface in an electronic device and an electronic device thereof.

In accordance with an aspect of the present disclosure, a method for displaying a user interface in an electronic device is provided. The method includes obtaining biometric information associated with a user of the electronic device from the electronic device, determining condition information (e.g., context information) associated with the user based on at least the biometric information, displaying a notification corresponding to the biometric information via a display functionally connected to the electronic device when the condition information corresponds to a first predefined condition, and automatically executing an application associated with the biometric information when the condition information corresponds to a second predefined condition.

In accordance with an aspect of the present disclosure, an electronic device is provided. The electronic device includes a sensor configured to receive information associated with at least one of a user and an ambient environment from the outside and a condition analysis module that is functionally connected to the sensor and is processor-implemented. Here, the condition analysis module may be configured to obtain biometric information associated with the user of the electronic device, determine condition information associated with the user based on at least the biometric information, display a notification corresponding to the biometric information via a display functionally connected to the electronic device when the condition information corresponds to a first predefined condition, and automatically execute an application associated with the biometric information when the condition information corresponds to a second predefined condition.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environmental system according to various embodiments of the present disclosure;

FIG. 2 is a block diagram illustrating an electronic device according to various embodiments of the present disclosure;

FIG. 3 is a block diagram illustrating a programming module according to various embodiments of the present disclosure;

FIG. 4 is a flowchart illustrating a method for displaying a user interface associated with biometric information in an electronic device according to various embodiments of the present disclosure;

FIG. 5 illustrates a structure of a network-based condition analysis system according to various embodiments of the present disclosure;

FIG. 6 is a block diagram illustrating a condition analysis module in an electronic device according to various embodiments of the present disclosure;

FIG. 7 illustrates an example in which a user interface for providing a notification corresponding to user biometric information is applied in an electronic device according to various embodiments of the present disclosure;

FIG. 8 illustrates an example in which a user interface for changing and/or providing a notification corresponding to user biometric information is applied in an electronic device according to various embodiments of the present disclosure;

FIG. 9 illustrates an example in which a user interface for providing a notification and/or application corresponding to user biometric information is applied in an electronic device according to various embodiments of the present disclosure;

FIG. 10 illustrates an example in which a user interface for providing a notification corresponding to user biometric information and/or a notification indicating an application associated with the user biometric information is applied in an electronic device according to various embodiments of the present disclosure;

FIG. 11A is a flowchart illustrating a method for executing an application associated with user biometric information in an electronic device according to various embodiments of the present disclosure;

FIG. 11B illustrates an example in which a user interface for providing information through a notification corresponding to user biometric information, a notification display user interface, and/or an application associated with the user biometric information in an electronic device according to various embodiments of the present disclosure;

FIG. 12 is a flowchart illustrating a method for executing a notification corresponding to user biometric information or an application associated with the user biometric information using a condition analysis module in an electronic device according to various embodiments of the present disclosure; and

FIG. 13 is a flowchart illustrating a method for executing a notification corresponding to user biometric information and/or an application associated with the user biometric information, and for changing a predefined condition and/or feedback information in an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure may have various embodiments, and modifications and changes may be made therein. Therefore, the present disclosure will be described with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a central processing unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various embodiments of the present disclosure may be a device. For example, the electronic device according to various embodiments of the present disclosure may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device (e.g., a head-mount-device (HMD), an electronic glasses, an electronic clothing, an electronic bracelet, an electronic necklace, an electronic accessory, an electronic tattoo, a smart mirror, or a smart watch).

In other embodiments, an electronic device may be a smart home appliance. For example, of such appliances may include at least one of a television (TV), a digital versatile disk (DVD) player, an audio component, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV), a game console (e.g., Xbox® PlayStation®), an electronic dictionary, an electronic key, a camcorder, or an electronic frame.

In other embodiments, an electronic device may include at least one of a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine), a navigation device, a global positioning system (GPS) receiver, an event data recorder (EDR), a flight data recorder (FDR), an in-vehicle infotainment device, an electronic equipment for a ship (e.g., ship navigation equipment and/or a gyrocompass), an avionics equipment, a security equipment, a head unit for vehicle, an industrial or home robot, an automatic teller's machine (ATM) of a financial institution, point of sale (POS) device at a retail store, or an internet of things device (e.g., a lightbulb, various sensors, an electronic meter, a gas meter, a sprinkler, a fire alarm, a thermostat, a streetlamp, a toaster, a sporting equipment, a hot-water tank, a heater, or a boiler and the like)

In certain embodiments, an electronic device may include at least one of a piece of furniture or a building/structure, an electronic board, an electronic signature receiving device, a projector, and various measuring instruments (e.g., a water meter, an electricity meter, a gas meter, or a wave meter).

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

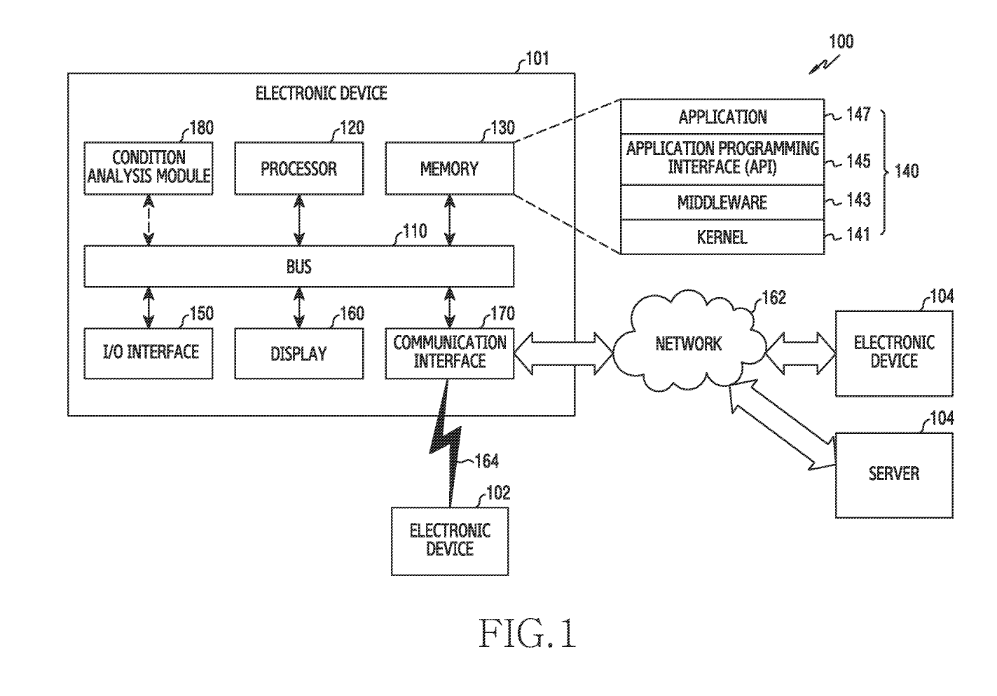

FIG. 1 illustrates a network environmental system according to various embodiments of the present disclosure.

Referring to FIG. 1, according to various embodiments of the present disclosure, an electronic device 101 within a network environment 100 is illustrated. The electronic device 101 may include a bus 110, a processor 120, a memory 130, an I/O (input/output) interface 150, a display 160, a communication interface 170, and a condition analysis module 180. In some embodiments, the electronic device 101 may omit at least one of the components, or additionally include other components.

The bus 110 may include, for example, a circuit that interconnects components 110 to 180 and transmits communication (e.g., control message and/or data) among the components.

The processor 120 may include at least one of a CPU, an AP, and a communication processor (CP). The processor 120 may perform operations or data processing which is associated with control and/or communication of one or more other components of the electronic device 101.

The memory 130 may include a volatile and/or non-volatile memory. The memory 130 may store, for example, instructions or data associated with the one or more other components of the electronic device 101.

According to an embodiment, the memory 130 may store software and/or programs 140. The program 140 may include, for example, a kernel 141, a middleware 143, an application programming interface (API) 145, and/or an application program (or “application”) 147. At least a part of the kernel 141, the middleware 143, or the API 145 may be referred to as an operating system (OS).

The kernel 141 may control or manage, for example, system resources (e.g., the bus 110, the processor 120, the memory 130, etc.) which are used to execute operations or functions implemented in other programs (e.g., the middleware 143, the API 145, or the application program 147). In addition, the kernel 141 may include an interface that can access individual components of the electronic device 101 in the middleware 143, the API 145, or the application program 147 to thereby control or manage the system resources.

The middleware 143 may act as an intermediary so that the API 145 or the application program 147 communicates with the kernel 141 to transmit and receive data.

In addition, the middleware 143 may process one or more operation requests which have been received from the application program 147, according to a priority. For example, the middleware 143 may assign a priority capable of using the system resources (e.g., the bus 110, the processor 120, the memory 130, etc.) of the electronic device 101 to at least one of the application programs 147. For example, the middleware 143 may perform scheduling or load balancing for the one or more operation requests, by processing the one or more operation requests according to the priority assigned to at least one of the application programs 147.

The API 145 is an interface for controlling a function provided from the kernel 141 or the middleware 143 by the application 147, and may include, for example, one or more interface or function (e.g. commands) for file control, window control, image processing, or character control, and the like.

The I/O interface 150 may act as, for example, an interface that can transmit instructions or data input from a user or other external devices to the other component(s) of the electronic device 101. In addition, the I/O interface 150 may output the instructions or data received from the other component(s) of the electronic device 101 to the user or the other external devices.

The display 160 may include, for example, a liquid crystal display (LCD), a light-emitting diode (LED) display, an organic light-emitting diode (OLED) display, a micro-electromechanical system (MEMS) display, an electronic paper display, or the like. The display 160 may display, for example, a variety of contents (e.g., texts, images, videos, icons, symbols, etc.) to a user. The display 160 may include a touch screen, and receive, for example, a touch, a gesture, a detection of a proximity, a detection of a hovering input using an electronic pen or a part of a user's body, etc.

The communication interface 170 may set communication between, for example, the electronic device 101 and an external device (e.g., a first external electronic device 102, a second external electronic device 104, or a server 106). For example, the communication interface 170 may be connected to a network 162 through wireless communication or wired communication to thereby communicate with the external device (e.g., the second external electronic device 104 or the server 106).

The wireless communication may be, for example, a cellular communication protocol, and use, for example, at least one of long-term evolution (LTE), LTE-Advanced (LTE-A), code division multiple access (CDMA), wideband CDMA (WCDMA), universal mobile telecommunications system (UMTS), wireless broadband (WiBro), and global system for mobile communications (GSM). In addition, the wireless communication may include, for example, short-range communication 164. The short-range communication 164 may include, for example, at least one of wireless fidelity (Wi-Fi), Bluetooth, near field communication (NFC), and global positioning system (GPS). The wired communication may include, for example, at least one of universal serial bus (USB), high definition multimedia interface (HDMI), recommended standard 232 (RS-232), and plain old telephone service (POTS). The network 162 may be a communications network, and include, for example, at least one of a computer network (e.g., local-area network (LAN) or wide area network (WAN)), the Internet, and a telephone network.

The condition analysis module 180 may display, for example, a notification corresponding to biometric information associated with a user to the user, or automatically execute an application (or function) associated with the biometric information.

According to an embodiment, the condition analysis module 180 may obtain biometric information associated with the user, and determine condition information based on the obtained biometric information.

According to an embodiment, the condition analysis module 180 may compare the obtained biometric information and/or the condition information with a predefined condition, display a notification corresponding to the biometric information through the display 160, or automatically execute the application (or function) associated with the biometric information. For example, the condition analysis module 180 may display the notification corresponding to the biometric information when the biometric information and/or the condition information corresponds to a first predefined condition, and automatically execute the application associated with the biometric information when the biometric information and/or the condition information corresponds to a second predefined condition.

According to an embodiment, the condition analysis module 180 may be integrated with a second processor (not shown, e.g., a lower power processor such as a sensor hub) functionally connected to a first processor (e.g., the processor 120) to thereby be implemented, or separated into the first processor and the second processor to thereby be implemented. The condition analysis module 180 may be distributed in, for example, at least one of a processor and a memory built in each of the electronic device 101 and the first external electronic device 102 to thereby implemented.

According to an embodiment, the condition analysis module 180 may transmit and receive at least one of the biometric information and the condition information to the external device (e.g., the first external electronic device 102, the second external electronic device 104, or the server 106) through the network 162.

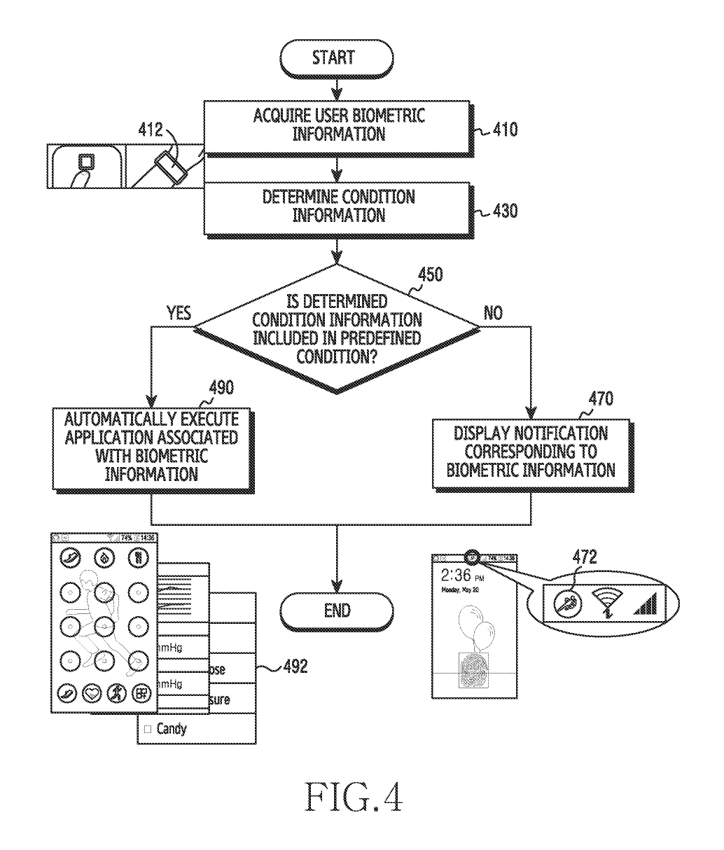

In FIG. 1, the condition analysis module 180 is illustrated as a component being independent of the processor 120 and the memory 130, but various embodiments are not limited thereto. The condition analysis module 180 may be integrated with the processor 120 to thereby be implemented, or stored in the memory 130 in software to thereby be implemented in the form that can be executed in the processor 120. The condition analysis module 180 may be distributed in the processor 120 and the memory 130 to thereby be implemented. Additional information associated with the condition analysis module 180 will be described below in connection with FIGS. 4 to 13.

At least one of the first external electronic device 102 and the second external electronic device 104 and the electronic device 101 may be the same or a different kind of device. According to an embodiment, the server 106 may include a group of one or more servers. According to various embodiments, all or some of operations performed in the electronic device 101 may be performed in another electronic device, a plurality of electronic devices (e.g., the electronic devices 102 and 104), or the server 106. According to an embodiment, when it is required to execute some functions or services automatically or in response to requests, the electronic device 101 may additionally request at least some of the functions associated with the electronic device 101 from other devices (e.g., the electronic devices 102 and 104) or the server 106, instead of autonomously executing the function or the service. The other electronic devices (e.g., the electronic devices 102 and 104) or the server 106 may execute the requested function or the additional function, and transmit the execution result to the electronic device 101. The electronic device 101 may process the received result as is or additionally and thereby provide the requested function or service. For this, for example, cloud computing, distributed computing, or client-server computing technologies may be used.

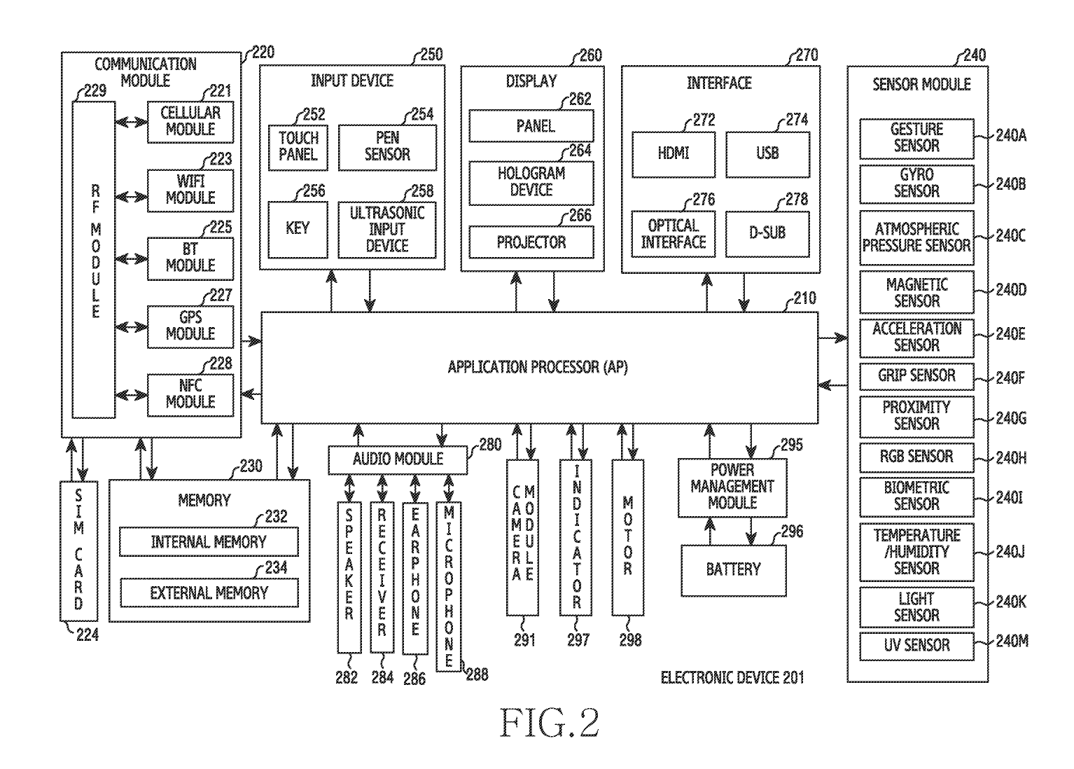

FIG. 2 is a block diagram illustrating an electronic device according to various embodiments of the present disclosure.

Referring to FIG. 2, the electronic device 201 may include all or some of the components of the electronic device 101 illustrated in FIG. 1. The electronic device 201 may include one or more processors (e.g., AP 210), a communication module 220, a subscriber identity module 224, a memory 230, a sensor module 240, an input device 250, a display 260, an interface 270, an audio module 280, a camera module 291, a power management module 295, a battery 296, an indicator 297, and a motor 298.

The processor 210 may drive, for example, an OS or an application program to control a plurality of hardware or software components connected to the processor 210 and to perform a variety of data processing and operations. The processor 210 may be implemented in a system on chip (SoC).

According to an embodiment of the present disclosure, the processor 210 may further include a graphic processing unit (GPU) and/or an image signal processor. The processor 210 may include at least some (e.g., a cellular module 221) of the components illustrated in FIG. 2. The processor 210 may load an instruction or data received from at least one of the other components (e.g., a non-volatile memory) to a volatile memory to process the loaded instruction or data, and store a variety of data in the non-volatile memory.

The communication module 220 may have the same as or similar to the communication interface 170 of FIG. 1. The communication module 220 may include, for example, the cellular module 221, a Wi-Fi module 223, a Bluetooth module 225, a GPS module 227, an NFC module 228, and a radio frequency (RF) module 229.

The cellular module 221 may provide voice calls, video calls, SMSs, Internet services, etc., through, for example, a communication network.

According to an embodiment, the cellular module 221 may perform identification and authentication of the electronic device 201 within a communication network, using a subscriber identity module (e.g., a SIM card) 224.

According to an embodiment, the cellular module 221 may perform at least some of functions that can be provided by the processor 210.

According to an embodiment, the cellular module 221 may include a CP.

At least one of the Wi-Fi module 223, the Bluetooth module 225, the GPS module 227, and the NFC module 228 may include, for example, a processor for processing data transmitted and received through the corresponding module.

According to some embodiments, at least some (e.g., two or more) of the cellular module 221, the Wi-Fi module 223, the Bluetooth module 225, the GPS module 227, and the NFC module 228 may be included within a single integrated chip (IC) or an IC package.

The RF module 229 may transmit and receive, for example, communication signals (e.g., RF signals). The RF module 229 may include, for example, a transceiver, a power amplifier module (PAM), a frequency filter, a low noise amplifier (LNA), an antenna, or the like.

According to another embodiment, at least one of the cellular module 221, the Wi-Fi module 223, the Bluetooth module 225, the GPS module 227, and the NFC module 228 may transmit and receive the RF signals through a separate RF module.

The subscriber identity module 224 may include, for example, a card and/or an embedded SIM each having subscriber identity information, and include unique identification information (e.g., integrated circuit card identifier (ICCID)) or subscriber information (e.g., international mobile subscriber identity (IMSI)).

The memory 230 (e.g., the memory 130) may include, for example, an internal memory 232 or an external memory 234. The internal memory 232 may include, for example, at least one of a volatile memory (e.g., a dynamic RAM (DRAM), an static RAM (SRAM), an synchronous dynamic RAM (SDRAM), or the like) and a non-volatile memory (e.g., an one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, a NOR flash, or the like), a hard drive, or a solid state drive (SSD)).

The external memory 234 may further include a flash drive, for example, a compact flash (CF), a secure digital (SD), a micro secure digital (micro-SD), a mini secure digital (Mini-SD), an extreme digital (xD), a Multi Media Card (MMC), a memory stick, or the like. The external memory 234 may be functionally and/or physically connected to the electronic device 201 through various interfaces.

The sensor module 240 may measure, for example, a physical quantity or detect an operation state of the electronic device 201 and thereby convert the measured and detected information into electric signals. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., an red, green, and blue (RGB) sensor), a biometric sensor 240I, a temperature/humidity sensor 240J, a luminance sensor 240K, and a ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein.

According to embodiments of the present disclosure, the electronic device 201 may further include a processor that is configured to control the sensor module 240 as a part of the processor 210 or separately from the processor 210, so that the sensor module 240 may be controlled even while the processor 210 is in a sleep state.

The input device 250 may include, for example, a touch panel 252, a (digital) pen sensor 254, a key 256, or an ultrasonic input device 258. The touch panel 252 may use at least one of an electrostatic scheme, a pressure-sensitive scheme, an infrared scheme, and an ultrasonic scheme. In addition, the touch panel 252 may further include a control circuit. The touch panel 252 may further include a tactile layer, and thereby provide a user with a tactile reaction.

The (digital) pen sensor 254 may be, for example, a part of the touch panel, or include a separate sheet for recognition. The key 256 may include, for example, physical buttons, an optical key, or a keypad. The ultrasonic input device 258 may detect ultrasonic waves generated from an input tool via a microphone (e.g., a microphone 288), and determine data corresponding to the detected ultrasonic waves.

The display 260 (e.g., the display 160) may include a panel 262, a hologram device 264, or a projector 266. The panel 262 may be implemented in a flexible, transparent, or wearable manner. The panel 262 may be constructed as one module with the touch panel 252. The hologram device 264 may use an interference of light and show a stereoscopic image in the air. The projector 266 may project light to a screen and display an image. The screen may be positioned, for example, inside or outside the electronic device 201.

According to an embodiment, the display 260 may further include a control circuit for controlling the panel 262, the hologram device 264, or the projector 266.

The interface 270 may include, for example, an HDMI 272, a USB 274, an optical interface 276, or a d-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/multi-media card (MMC) interface, or an infrared data association (IrDA) standard interface.

The audio module 280 may bilaterally convert, for example, sounds and electric signals. At least some components of the audio module 280 may be included, for example, in the I/O interface 150 illustrated in FIG. 1. The audio module 280 may process sound information input or output via a speaker 282, a receiver 284, an earphone 286, the microphone 288, or the like.

The camera module 291 is a device for capturing, for example, still images and moving images, and according to an embodiment, may include one or more image sensors (e.g., a front sensor or a rear sensor), lens, an image signal processor (ISP), or a flash (e.g., an LED, a xenon lamp, or the like).

The power management module 295 may manage, for example, power of the electronic device 201.

According to an embodiment, the power management module 295 may include a power management integrated circuit (PMIC), a charger integrated circuit (IC), or a battery or fuel gauge. The PMIC may have wired and/or wireless charging schemes. The wireless charging scheme may include, for example, a magnetic resonance type, a magnetic induction type, an electromagnetic type, etc., and may further include an additional circuit for wireless charging, for example, a coil loop, a resonant circuit, a rectifier, or the like. The battery gauge may measure, for example, a residual quantity of the battery 296 and a voltage, a current, and a temperature, such as during charging. The battery 296 may include a rechargeable battery and/or a solar battery.

The indicator 297 may indicate a specific state, e.g., a booting state, a message state, a charging state, and the like of the electronic device 201 or a part thereof (e.g., the processor 210). The motor 298 may convert an electric signal into a mechanical vibration, and generate a vibration, a haptic effect (e.g., haptic feedback or force feedback), etc. Although not shown, the electronic device 201 may include a processing unit (e.g., GPU) for supporting a mobile TV. The processing unit for supporting the mobile TV may process media data according to a protocol of, for example, digital multimedia broadcasting (DMB), digital video broadcasting (DVB), or MediaFlo™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

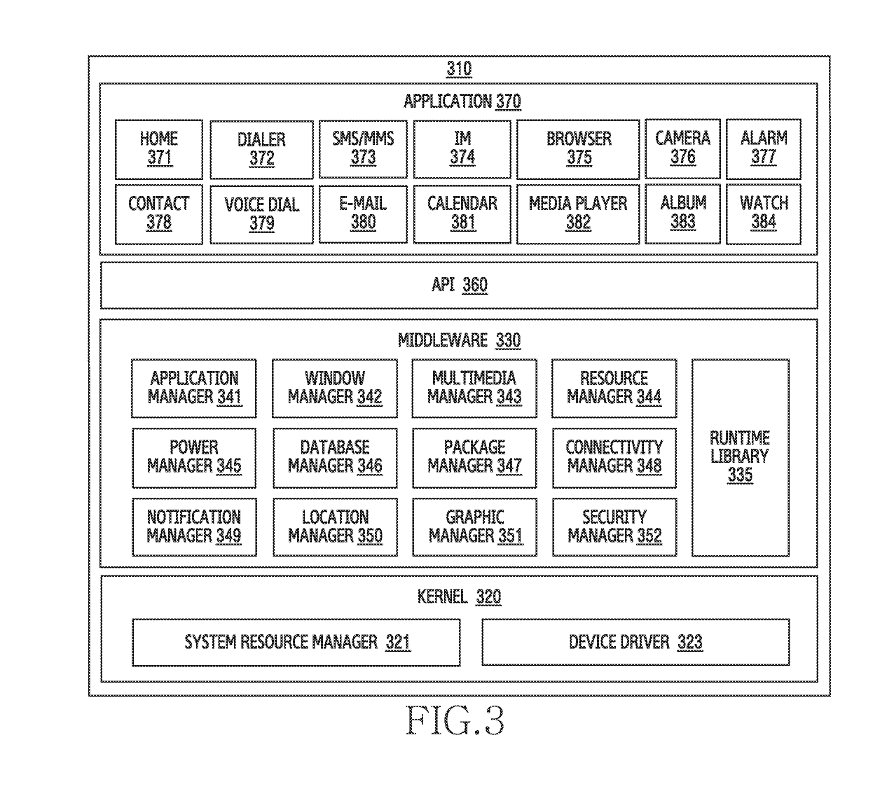

FIG. 3 is a block diagram illustrating a programming module according to various embodiments of the present disclosure.

Referring to FIG. 3, a programming module 310 (e.g., the program 140) may include an OS that controls resources associated with an electronic device (e.g., the electronic device 101) and/or a variety of applications (e.g., the application program 147) driven on the OS. The OS may be, for example, Android™, iOS™, Windows™, Symbian™, Tizen™, Samsung Bada Os™, or the like.

The programming module 310 may include a kernel 320, a middleware 330, an API 360, and/or an application 370. At least a part of the programming module 310 may be preloaded on the electronic device, or downloaded from an external electronic device (e.g., the electronic devices 102 and 104, the server 106, or the like).

The kernel 320 (e.g., the kernel 141) may include, for example, a system resource manager 321 and/or a device driver 323. The system resource manager 321 may perform the control, allocation, recovery or the like of system resources.

According to an embodiment, the system resource manager 321 may include a process management unit, a memory management unit, a file system management unit, etc. The device driver 323 may include, for example, a display driver, a camera driver, a Bluetooth driver, a shared memory driver, a USB driver, a keypad driver, a Wi-Fi driver, an audio driver, or an IPC (inter-process communication) driver.

The middleware 330 may provide, for example, a function required in common by the applications 370, or provide a function to the applications 370 through the API 360 in order to enable the applications 370 to efficiently use limited system resources within the electronic device.

According to an embodiment, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module used by a complier, in order to add a new function by using a programming language during the execution of the application 370. The runtime library 335 may perform functions which are related to the management of input and output, the management of a memory, an arithmetic function, and/or the like.

The application manager 341 may manage, for example, a life cycle of at least one of the applications 370. The window manager 342 may manage graphical user interface (GUI) resources used on the screen. The multimedia manager 343 may detect a format required for reproducing various media files and encode or decode a media file through a codec appropriate for the relevant format. The resource manager 344 may manage resources such as a source code, a memory, a storage space, and/or the like of at least one of the applications 370.

The power manager 345 may operate, for example, together with a basic input/output system (BIOS) to manage a battery or power, and provide information and the like required for the operation of the electronic device. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connection such as Wi-Fi or Bluetooth. The notification manager 349 may display or report, to a user, an event such as an arrival message, an appointment, a proximity alarm, or the like in such a manner as not to disturb the user. The location manager 350 may manage location information of the electronic device. The graphic manager 351 may manage a graphic effect which is to be provided to the user, and/or a user interface related to the graphic effect. The security manager 352 may provide various security functions required for system security, user authentication, and the like. According to an embodiment, when the electronic device (e.g., the electronic device 101) has a telephone function, the middleware 330 may further include a telephony manager for managing a voice telephony call function or a video telephony call function of the electronic device.

The middleware 330 may include a middleware module that forms a combination of various functions of the above-described components. The middleware 330 may provide modules specialized according to types of OSs in order to provide differentiated functions. Also, the middleware 330 may dynamically delete some of the existing components, or add new components.

The API 360 (e.g., the API 145) may be a set of API programming functions, each of which is provided with a different configuration according to an OS. For example, in the case of Android or iOS, one API set may be provided to each platform, and in the case of Tizen™, two or more API sets may be provided to each platform.

The applications 370 (e.g., the application program 147) may include, for example, one or more applications that can perform functions, such as a home 371, a dialer 372, an SMS/MMS 373, an instant message (IM) 374, a browser 375, a camera 376, an alarm 377, a contact 378, a voice dial 379, an electronic mail (e-mail) 380, a calendar 381, a media player 382, an album 383, a clock (e.g., a watch) 384, a health care function (e.g., measuring momentum, a blood glucose, and the like), environmental information providing function (e.g., providing an atmospheric pressure, humidity, temperature information, and the like), and the like.

According to an embodiment, the applications 370 may include an application (hereinafter, for convenience of description, referred to as “information exchange application”) for supporting information exchange between an electronic device (e.g., the electronic device 101) and an external electronic device (e.g., the electronic devices 102 and 104). The information exchange application may include, for example, a notification relay application for relaying specific information to the external electronic device or a device management application for managing the external electronic device.

For example, the notification relay application may include a function for relaying, to the external electronic device (e.g., the electronic devices 102 and 104), notification information generated from other applications (e.g., SMS/MMS application, e-mail application, health care application, environmental information application, and the like) of the electronic device. Also, the notification relay application may receive notification information from, for example, the external electronic device and provide the received notification information to the user.

The device management application may manage (install, delete, or update), for example, one or more functions (e.g., turn-on/turn-off of the external electronic device itself (or some components) or adjustment of brightness (or resolution) of a display) of the external electronic device (e.g., the electronic devices 102 and 104) communicating with the electronic device, applications operated in the external electronic device, or services (e.g., call service or message service) provided from the external electronic device.

According to an embodiment, the applications 370 may include an application (e.g., a health care application of a mobile medical device) predefined according to an attribute of the external electronic device (e.g., the electronic devices 102 and 104).

According to an embodiment, the applications 370 may include an application received from the external electronic device (e.g., the server 106 or the electronic devices 102 and 104).

According to an embodiment, the application 370 may include a preloaded application or a third party application that can be downloaded from a server. Names of the components of the programming module 310 according to the illustrated embodiment may vary according to the type of the OS.

According to various embodiments, at least a part of the programming module 310 may be implemented in software, firmware, hardware, or a combination of at least two thereof. The at least a part of the programming module 310 may be implemented (e.g., executed) by, for example, a processor (e.g., the processor 210). The at least a part of the programming module 310 may include, for example, a module, a program, a routine, a set of instructions, a processor, or the like for performing one or more functions.

FIG. 4 is a flowchart illustrating a method for displaying a user interface associated with biometric information in an electronic device according to various embodiments of the present disclosure.

Referring to FIG. 4, in operation 410, an electronic device (e.g., the condition analysis module 180 of FIG. 1) may obtain, for example, biometric information associated with the user (e.g., a skin moisture ratio, a galvanic skin response (GSR), a heart rate monitor (HRM), heart rate variability (HRV), the number of occurrences of a heart rate pattern, a blood pressure, a pulse wave, oxygen saturation (SpO2), electrocardiogram (ECG), an acceleration, a motion, a sound, a smell, a taste, brain wave information, and the like.

According to an embodiment, the electronic device may obtain one or more pieces of biometric information through, for example, a sensor 412 (e.g., the sensor module 240 of FIG. 2) functionally connected to the electronic device.

According to an embodiment, the sensor 412 may include at least one of a skin moisture sensor, a GSR sensor, a heart rate sensor, a photoplethysmograph (PPG) sensor, an oxygen saturation sensor, an ECG sensor, an acceleration sensor, a motion sensor, a sound sensor, a gas sensor (e.g., an eNose sensor), a taste sensor, and a brain wave sensor.

According to various embodiments, the electronic device may receive the biometric information associated with the user from an external device (e.g., the first external electronic device 102, the second external electronic device 104, or the server 106). For example, the electronic device may receive or obtain the biometric information associated with the user obtained from a sensor module (e.g., the sensor module 240) of the external device, through a communication interface (e.g., the communication interface 170 of FIG. 1) functionally connected to the electronic device. Also, the biometric information may further include other pieces of information (e.g., a place or a time in which biometric information is measured, application information, preferred media, exercise friend contacts, recommended contents, weather, temperature, humidity, a calendar schedule, food information, and the like) which is not directly associated with the user's body, as a part of the biometric information.

According to various embodiments, the electronic device may receive or determine state information of the electronic device or the external device for measuring the biometric information, as the other pieces of information which is not directly associated with the user's body. For example, the state information may include a communication state (e.g., communication connection, during communication, communication interruption, etc.) between the electronic device and the external device and/or an operation state (e.g., a wear state, a measurement operation state, occurrence/non-occurrence of error, etc.) of the sensor module functionally connected to the electronic device or the external device. Also, the state information may include a history associated with the biometric information of the user, personal information of the user (e.g., a calendar schedule, a medication, a surgical history, a height, an age, or a body weight, etc.), management information of the user (e.g., an administration time, calendar information, etc.), or direction information of the electronic device (e.g., GPS information, digital compass information, geomagnetic sensor information, etc.).

In operation 430, the electronic device (e.g., the condition analysis module 180 of FIG. 1) may determine one or more pieces of state information associated with the user (e.g., sweat, a heart rate, a degree of tension, muscle fatigue, a motion, a posture, a time, a location, a movement distance, sleep, wake-up (awakening state), user personal information, health information, exercise information, administration information, etc.), based on, for example, the one or more pieces of biometric information.

According to an embodiment, the condition information associated with the user may include, for example, information about conditions (e.g., a sleep state, a motion state, a health state, an emotional state of the user, etc.) of the user or information about conditions (e.g., an atmospheric pressure, weather, a temperature, humidity, etc.) of an ambient environment of the user or the electronic device. The condition information may include, for example, condition items and condition values corresponding to the condition items in order to indicate the conditions of the user.

According to an embodiment, condition information corresponding to a condition in which a user's heart rate is 80 beats per minute (e.g., 80 bpm) may include, for example, data indicating a heart rate as condition items, and data indicating 80 beats per minute (e.g., 80 bpm) as condition values corresponding to the foregoing condition items.

According to an embodiment, when the biometric information is, for example, a skin moisture ratio, the electronic device may determine, as sweat, the condition item of the condition information associated with the user. In relation to the condition of the user, the electronic device may determine, for example, that the user is sweating. The electronic device may determine the condition value corresponding to the corresponding condition item (e.g., a value associated with a degree of perspiration, a stress value (index), a value associated with an ovulation date (of the female), or the like), based on the value of the skin moisture ratio.

In addition, when the biometric information is HRM information, the electronic device may determine the condition item of the condition information associated with the user as the heart rate. The electronic device may determine the heart rate of the user through a numerical value (e.g., a value) of the HRM information. Also, when the biometric information is HRV information obtained through a sensor (e.g., a PPG sensor) functionally connected to the electronic device, the electronic device may determine the condition item of the condition information associated with the user as a stress state. The electronic device may determine a stress index of the user through a numerical value (e.g., value) of HRV information. Also, when the biometric information is HRV information, the electronic device may determine the condition item as an emotional state (e.g., joy, sadness, surprise, arousal, anger, etc.) among the user's conditions, and determine an index (e.g., a ratio to emotion stage/emotion maximum stage or maximum value) corresponding to the emotional state of the user through the value of HRV information.

According to various embodiments, the electronic device may determine the condition information associated with the user using a plurality of pieces of biometric information.

According to an embodiment, the electronic device may obtain the plurality of pieces of biometric information, for example, the skin moisture ratio and HRM information, and determine the condition information associated with the user based on the obtained skin moisture ratio and HRM information. The electronic device may determine, as the degree of tension or the stress state, the condition items of the condition information to be determined in relation to the user on the basis of, for example, the fact that the obtained biometric information is the skin moisture ratio and HRM information, and determine the condition value (a value associated with the degree of tension or stress state of the user) corresponding to the corresponding condition item by using or combining the skin moisture ratio and the numerical value (e.g., value) of the HRM information.

In the above-described embodiments, a case in which the condition information includes both the condition item and the condition value has been described, but this is merely an example, and other cases are possible. For example, the condition information may include only the condition item, and in this case, the electronic device may use the numerical value of the biometric information corresponding to the corresponding condition item, instead of using the condition value when performing determination based on the condition information. For example, when the condition item of the condition information is sweat, the value of the skin moisture ratio that is the biometric information corresponding to the condition item may be set to be used, without enabling separate value information (the condition value) (e.g., a value associated with a degree of perspiration) associated with perspiration to be included in the condition information.

In operation 450, the electronic device (e.g., the condition analysis module 180 of FIG. 1) may determine whether the determined condition information is included in (or corresponds to) a predefined condition.

According to an embodiment, the electronic device may determine whether the determined condition information is included in the predefined condition, and perform an additional operation associated with the predefined condition based on information about whether the determined condition information is included in the predefined condition. The predefined condition may include, for example, a predefined item (e.g., sweat or a heart rate) and a reference value (e.g., a value of the skin moisture ratio or a value of the heart rate) that is a reference of whether the determined condition information is included in the predefined condition in relation to the corresponding item. The reference value may be either a value which is directly associated with the predefined item or a value of the biometric information corresponding to the predefined item. For example, when the predefined item is sweat, the value of the skin moisture ratio that is the biometric information corresponding to sweat may be used as the reference value associated with the predefined condition. For example, when the predefined item is a heart rate, a value of the heart rate may be used as the reference value associated with the predefined condition. Other embodiments are also possible.

When the value of the skin moisture ratio is larger than the reference value set in relation to the predefined condition, the electronic device may determine that the value of the skin moisture ratio is included in the predefined condition, and when the value of the skin moisture ratio is equal to or smaller than the reference value set in relation to the predefined condition, the electronic device may determine that the value of the skin moisture ratio is not included in the predefined condition.

According to various embodiments, the predefined condition may include a plurality of conditions having various levels (degrees) with respect to the same item. The predefined condition may include, for example, a first condition, a second condition, and a third condition in relation to the item of the heart rate. The second condition may be a condition corresponding to a relatively higher HRM value compared to the first condition, and the third condition may be a condition corresponding to a relatively higher HRM value compared to the second condition. The electronic device may include a plurality of reference ranges as reference values corresponding to the item of the predefined condition in order to determine the predefined condition using such various levels. For example, the electronic device may divide and set the values of the HRM information into a first range (e.g., about 0 to 80), a second range (e.g., about 81 to 120), and a third range (e.g., about 121 to 160), as the reference values associated with the item of the heart rate. When the value of the HRM information is included in the first range, the electronic device may determine that the corresponding condition information is included in a first predefined condition. For example, when the value of the HRM information is included in the second range, the electronic device may determine that the corresponding condition information is included in a second predefined condition, and when the value of the HRM information is included in the third range, the electronic device may determine that the corresponding condition information is included in a third predefined condition.

According to various embodiments, different types of numerical values may be combined and set, as the reference value corresponding to the item of the predefined condition. For example, when the item of the predefined condition is a degree of tension, the value of the skin moisture ratio and the value of the HRM information may be combined and set as the reference value corresponding to the degree of tension. When the value of the skin moisture ratio is larger than a value (e.g., about 30%) set in advance in the electronic device and the value of the HRM information is included in a range (e.g., about 121 to 160) set in advance, the electronic device may determine that the item of the degree of tension is included in the predefined condition. Also, when the value of the skin moisture ratio is smaller than the value set in advance or the value of the HRM information is not included in the range (e.g., about 121 to 160) set in advance, the electronic device may determine that the item of the degree of tension is not included in the predefined condition.

According to various embodiments, the item of the predefined condition may include at least one of a place (e.g., home, office, or the like), a location, or a time in which the biometric information is measured, and a state (e.g., a power saving mode) or a type (e.g., a mobile device, a tablet, or a wearable device) of the electronic device that has obtained the biometric information, as well as the reference value (e.g., a numerical value) corresponding to the item of the predefined condition. For example, when the item of the predefined condition is a place in which the biometric information is measured and the information corresponding to the item of the predefined condition is a home, the electronic device may determine that the corresponding condition information is included in the predefined condition.

According to an embodiment, the electronic device may use additional information when determining information corresponding to the item of the predefined condition. For example, when a signal strength from an access point (AP) installed in the home is detected to be higher than a predefined value, when the location of the electronic device is determined to be the home based on information included in a Wi-Fi fingerprint, or when the location of the electronic device is determined to be the home by analyzing information of an input/output detection system, the electronic device may determine that the information corresponding to the item of the predefined condition is the home. Also, when the item of the predefined condition is the state of the electronic device and the information corresponding to the item of the predefined condition is a power saving mode, the electronic device may determine that the corresponding condition information is included in the predefined condition. Also, when at least one of the place in which the biometric information is measured and/or the state of the electronic device is different from the information (e.g., the home or the power saving mode) corresponding to the item of the predefined condition, the electronic device may determine that the determined condition information is not included in the predefined condition.

According to various embodiments, the predefined condition may be set in advance (previously) in the electronic device (in a manufacturing process of the electronic device), and may be generated or changed based on a user input (e.g., a touch, a double touch, a long press, a left/right movement after a touch, a gesture, or a drag and drop). Also, the predefined condition may be generated or changed based on information received from or transmitted to the external device. Also, the predefined condition may be automatically set based on the biometric information and/or the condition information. For example, when a pulse wave of the user is obtained from a body (e.g., finger, back of hand, ears, etc.) of the user through a sensor (e.g., a PPG sensor) functionally connected to the electronic device, the electronic device may set a degree of proximity or a degree of adhesion between the sensor and the skin of the user as a condition item of the predefined condition.

In operation 470, when it is determined that the determined condition information is not included in the predefined condition in operation 450, the electronic device (e.g., the condition analysis module 180 of FIG. 1) may display, for example, a notification (e.g., indicator, icon, widget, or the like) corresponding to the biometric information via a display (e.g., the display 160 of FIG. 1) functionally connected to the electronic device.

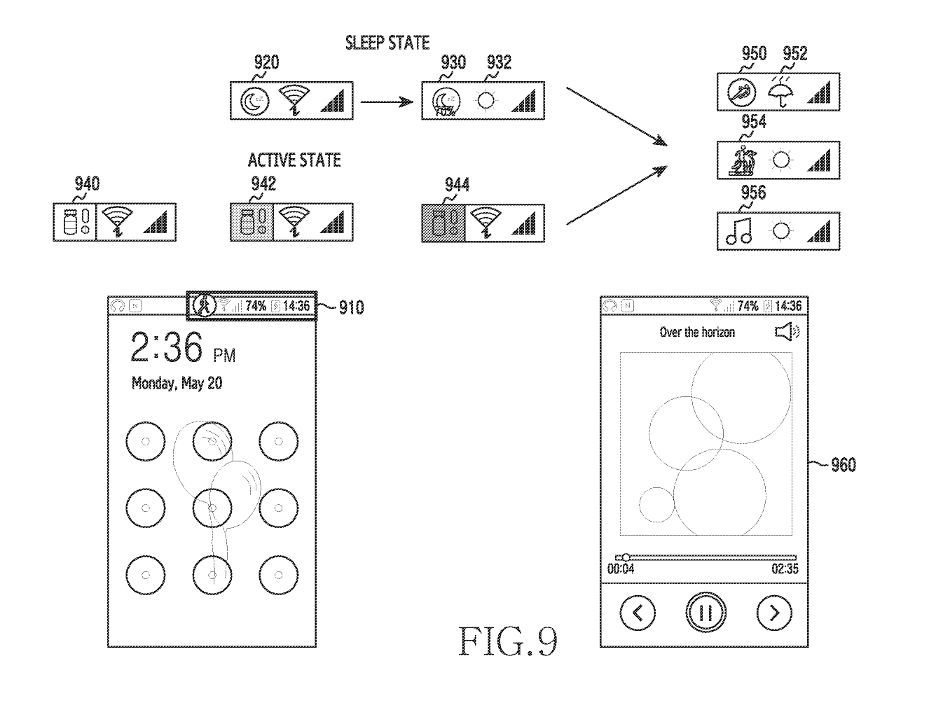

According to an embodiment, the electronic device may determine condition information associated with a user's motion (e.g., steps) via the sensor 412 (e.g., the acceleration sensor 240E of FIG. 2). When a value (e.g., the number of steps) obtained via the sensor 412 is not included in the predefined condition (e.g., the number of steps of about 100 or larger/minute), the electronic device may use a notification displayed on at least a part of the display or a step (walking) notification 472 as a user interface. Additional information about the step notification 472 will be described below in relation to FIG. 9.

According to various embodiments, the electronic device may output a notification corresponding to the biometric information via an audio module (e.g., the audio module 280 and/or the motor 298 of FIG. 2) functionally connected to the electronic device. For example, when the predefined condition is not satisfied, the electronic device may generate a sound or a vibration via the audio module and/or the motor.

According to various embodiments, the electronic device may determine or change a position or a form (e.g., a type) of the notification corresponding to the biometric information and the device (e.g., the electronic device 101, the first external electronic device 102, the second external electronic device 104, or the server 106 of FIG. 1) in which the notification is displayed. For example, the electronic device may display the notification in an upper end of the display (e.g., the display 160 of FIG. 1) functionally connected to the electronic device. In addition, the electronic device may display the notification in the form of, for example, a circle. The notification may be displayed in, for example, other positions (e.g., the external device) other than the upper end of the display, or in other forms (e.g., a bar, a tile, and the like) other than the circle. In addition, the electronic device may set a region in which the notification is visually displayed. For example, the electronic device may display the region in which the notification is visually displayed, in at least a part of a region (e.g., a notification bar (in Android), a task bar (in Windows™), or the like) which is continuously visible in a predefined region of the display, or display the region in which the notification is visually displayed as a floating icon (e.g., an icon displayed in a foreground of a display). Other embodiments are also possible.

In operation 490, when it is determined that the corresponding condition information is included in the predefined condition in operation 450, the electronic device may automatically execute an application (or a function) associated with, for example, the biometric information.

According to an embodiment, the electronic device may determine a user's step as the condition item of the condition information, based on the number of steps of the user that is the biometric (activity) information obtained through the sensor 412 (e.g., the acceleration sensor 240E of FIG. 2). For example, when a value corresponding to the corresponding condition item coincides with a reference value or a range corresponding to the corresponding item of the predefined condition, the electronic device may automatically execute an application associated with the biometric information corresponding to the condition item among applications included in the electronic device, for example, a health application 492. In addition, the electronic device may display a variety of pieces of biometric information (e.g., the number of current steps, a heart rate, etc.) associated with the user using, for example, the health application 492 via the display. For example, the electronic device may determine a degree of proximity or a degree of adhesion between the PPG sensor and the user's skin based on a pulse wave that is the biometric information obtained through the PPG sensor functionally connected to the electronic device. For example, when the degree of proximity or the degree of adhesion is larger than a contact area (e.g., about 2 cm²) set in advance in the electronic device (e.g., when the contact area is large), the electronic device may automatically execute an application associated with the biometric information corresponding to the condition item among the applications included in the electronic device, for example, a heart rate measurement application (or function).

According to various embodiments, the electronic device may determine whether the corresponding condition information is included in the predefined condition using other pieces of information (e.g., time) which is not directly associated with the sensor 412 and the user's body, when automatically executing the application (or function) associated with the biometric information. For example, the electronic device may determine condition information associated with the user's motion (e.g., walking or running) through an acceleration sensor (e.g., the acceleration sensor 240E of FIG. 2), and determine a time (e.g., about 30 minutes or one hour) during which the user's motion continues through time information. For example, when the value (e.g., time) corresponding to the corresponding condition item coincides with the reference value or range corresponding to the corresponding item of the predefined condition, the electronic device may automatically execute an application associated with the biometric information corresponding to the condition item among the applications included in the electronic device, for example, the health application 492. In addition, the electronic device may display, via the display, a variety of pieces of biometric information (e.g., a time during which the user's motion continues, the number of current steps, a heart rate, etc.) associated with the user using, for example, the health application 492.

According to various embodiments, the electronic device may automatically execute a plurality of applications in response to the fact that the determined condition information is included in the predefined condition. For example, when condition information about the user's motion (e.g., convert to running during walking) is included in the predefined condition, the electronic device may simultaneously or sequentially execute the health application 492 and a music application.

According to various embodiments, the electronic device may recommend a predefined function or application in response to the fact that the determined condition information is included in the predefined condition. For example, when the condition information associated with the user's motion (e.g., running) is included in the predefined condition, the electronic device may recommend the predefined function or application which has been executed by the user. The electronic device may provide a music list through the music application or automatically play the music list, using the function or application which has been executed by the user. Also, the electronic device may provide the function (e.g., target momentum display, running course display, map function, call function, music play function, food recommendation, or the like) associated with the user's motion (e.g., running) in the form of a list. Also, the electronic device may execute the function associated with the user's motion based on a user's input (e.g., selection).

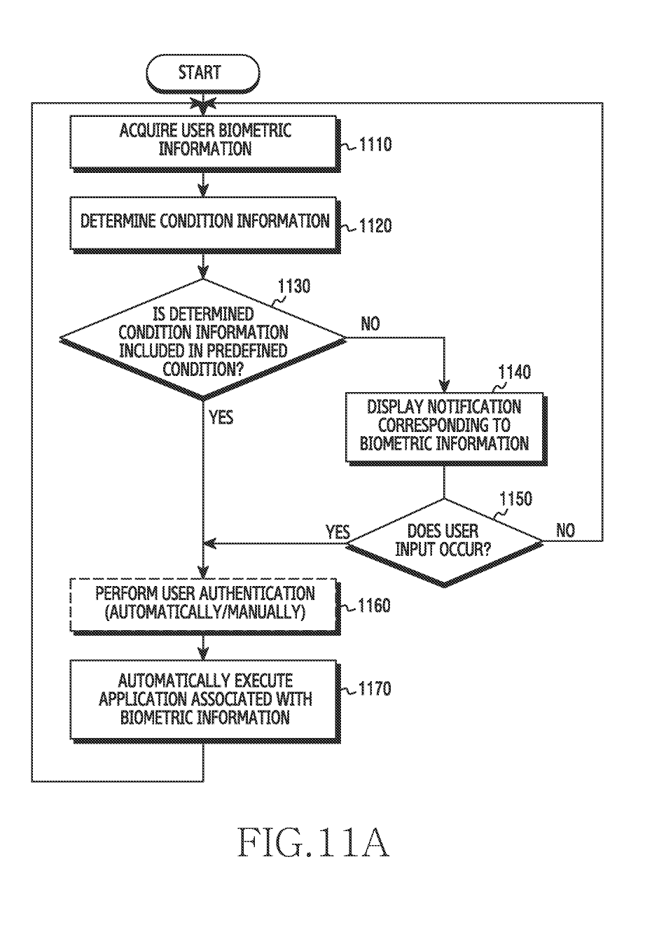

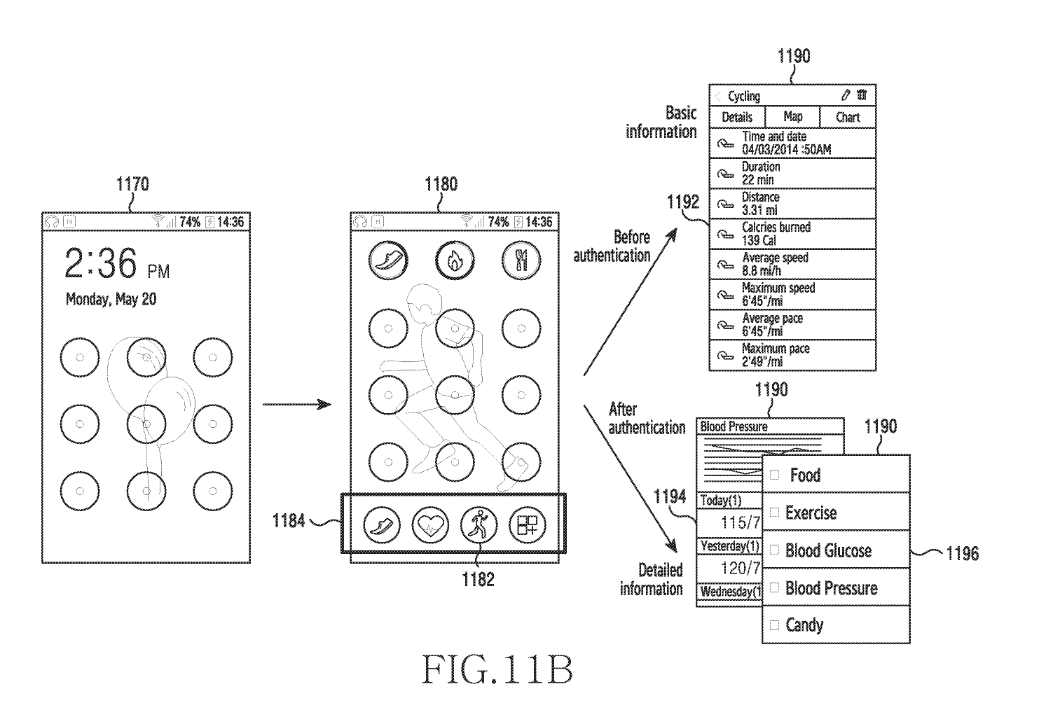

According to various embodiments, the electronic device may change a quantity (e.g., the number of pieces of the corresponding information or a type of the corresponding information) of the biometric information associated with the user displayed through the application while automatically executing the application (or function) associated with the biometric information. For example, when automatically executing the health application 492, the electronic device may display more types of biometric information (e.g., a skin moisture ratio, HRM, a brain wave, etc.) than those in a case of automatically executing the music application. Additional information about the health application 492 will be described below in relation to FIG. 11B.

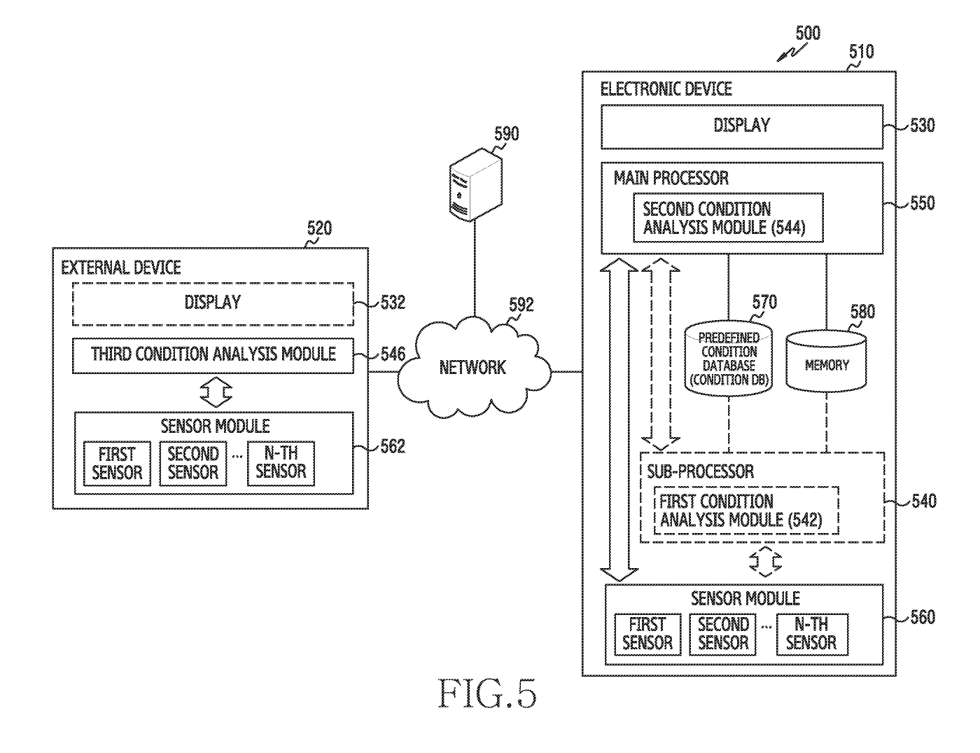

FIG. 5 illustrates a structure of a network-based condition analysis system according to various embodiments of the present disclosure.

Referring to FIG. 5, the condition analysis system 500 (e.g., the network environment 100 of FIG. 1) may include, for example, an electronic device 510 (e.g., the electronic devices 101 and 201), an external device 520 (e.g., the electronic devices 102 and 104), a server 590 (e.g., a cloud server and the server 106), and/or a network 592 (e.g., the network 162). The electronic device 510 may include, for example, a display 530 (e.g., the display 160 of FIG. 1), a main processor 550 (e.g., an AP), a sensor module 560 (e.g., the sensor module 240 of FIG. 2), a predefined condition database 570, a memory 580 (e.g., the memory 130 of FIG. 1), etc.

According to various embodiments, the electronic device 510 may further include a sub-processor 540 other than the above-described components, for example, the display 530, the main processor 550, the sensor module 560, the predefined condition database 570, and the memory 580. For example, the electronic device 510 may include the display 530, the main processor 550, the sensor module 560, the predefined condition database 570, and the memory 580, or further include the sub-processor 540. The sub-processor 540 may include, for example, a first condition analysis module 542, and the main processor 550 may include, for example, a second condition analysis module 544.

Here, an expression that the sub-processor 540 includes the first condition analysis module 542 refers to that a condition analysis function or operation of the first condition analysis module 542 is performed by the sub-processor 540. The first condition analysis module 542 may be integrated with the sub-processor 540 to be implemented, stored in the form of software in a (dedicated) memory area that is accessible by the sub-processor 540, and implemented in the form that can be executed in the sub-processor 540. The first condition analysis module 542 may be distributed in, for example, the sub-processor 540 and the memory 580, and implemented. This may be similarly applied to an expression that the main processor 550 includes the second condition analysis module 544.

The external device 520 may include, for example, a third condition analysis module 546 or a sensor module 562. Also, the external device 520 may further include a display 532 other than the above-described components, for example, the third condition analysis module 546 and the sensor module 562. For example, the external device 520 may include the third condition analysis module 546 and the sensor module 562 or further include the display 532. In addition, the sensor modules 560 and 562 may include a plurality of (one or more) sensors (e.g., the acceleration sensor 240E or the biometric sensor 240I of FIG. 2). In addition, the network 592 may include, for example, the network 162 illustrated in FIG. 1.

According to various embodiments, the electronic device 510 may perform condition analysis based on condition information obtained in the electronic device 510, using at least one of the first condition analysis module 542 included in the sub-processor 540 and the second condition analysis module 544 included in the main processor 550. For example, the electronic device 510 may determine or analyze whether biometric information obtained from the sensor module 560 functionally connected to the electronic device 510 is a predefined condition using the first condition analysis module 542 and/or the second condition analysis module 544. Also, the electronic device 510 may determine condition information associated with a user, based on the biometric information through, for example, at least one of the first condition analysis module 542 and/or the second condition analysis module 544.

According to various embodiments, conditions in which each of the first condition analysis module 542 and the second condition analysis module 544 is operated in the electronic device 510 may be set to be different from each other.

According to an embodiment, the sub-processor 540 may be driven by a low power module (e.g., a sensor hub) functionally connected to the electronic device 510, or may be at least one of processors corresponding to the low power module. Also, the electronic device 510 may obtain the biometric information from the sensor module 560 while using less power based on the sub-processor 540 through the low power module. Thus, in order to more efficiently (with a small power consumption and/or at a high speed) perform condition analysis based on the biometric information, the electronic device 510 may be configured so as to enable the first condition analysis module 542 that is a module for performing condition analysis to be included in the sub-processor 540. For example, when the first condition analysis module 542 is included in the sub-processor 540 or the low power module (e.g., the sensor hub), the electronic device 510 may not operate the main processor 550. For example, the electronic device 510 may obtain the biometric information through the first condition analysis module 542 included in the sub-processor 540 without operating the main processor 550 (e.g., by deactivating the main processor 550 or turning off the power of the main processor 550), when obtaining the biometric information associated with a user through the sensor module 560 functionally connected to the electronic device.

According to various embodiments, the electronic device 510 may determine whether to operate the second condition analysis module 544 using the first condition analysis module 542. For example, when the condition information is included in the predefined condition information, the electronic device 510 may operate the main processor 550 (e.g. activate the main processor 550 or turn on the power of the main processor 550) using the first condition analysis module 542 included in the sub-processor 540, and use the second condition analysis module 544 included in the main processor 550. For example, the electronic device 510 may execute an application associated with the condition information or perform additional condition analysis, using the second condition analysis module 544. For example, the electronic device 510 may obtain biometric information or additional information (e.g., weather information, user information, or the like) in order to perform additional condition analysis. For example, when performing the additional condition analysis, the electronic device 510 may perform condition analysis through a different scheme (e.g., a different reference value or a different range) from that of the first condition analysis module 542. On the other hand, when the condition information is not included in the predefined condition information, the electronic device may obtain the biometric information associated with the user using the first condition analysis module 542 included in the sub-processor 540 without operating the main processor 550 (e.g., by deactivating the main processor 550 or turning off the power of the main processor 550).

According to various embodiments, the electronic device 510 may change at least a part of information displayed through the display 530 included in the electronic device 510, based on the condition analysis module used by the electronic device 510 among the first condition analysis module 542 and the second condition analysis module 544. For example, the electronic device 510 may display a notification corresponding to the biometric information of the user in at least a partial region of the display 530 (e.g., a notification bar or a continuously displayed region) using the first condition analysis module 542. Also, when the main processor 550 is operated (e.g., the main processor 550 is activated or the power thereof is turned on), the electronic device 510 may execute an application included in the electronic device using the second condition analysis module 544. For example, when using the second condition analysis module 544, the electronic device 510 may display information (e.g., notification or application) displayed on the display 530 in a region wider than, or the same or similar region as or to that of information (e.g., notification) displayed when using the first condition analysis module 542. For example, the electronic device 510 may output a sound or generate a vibration or a haptic effect through an audio module (e.g., the audio module 280 of FIG. 2) and/or a motor (e.g., the motor 298 of FIG. 2, a tactile feedback device (not shown), or a friction display (not shown)), which is functionally connected to the electronic device 510, as the notification corresponding to the biometric information of the user using the first condition analysis module 542.

According to various embodiments, the electronic device 510 may control the operation of at least one of the first condition analysis module 542 and the second condition analysis module 544 based on at least one of an external input (e.g., a user input), a power state (e.g., a residual quantity of a battery), and other pieces of condition information associated with the electronic device 510. According to an embodiment, the electronic device 510 may perform or restrict the operation (e.g., activation) of at least one of the sub-processor 540 and the main processor 550 through the user input, or restrict the operation (e.g., activation) of at least one of the sub-processor 540 and the main processor 550 based on the residual quantity of a battery (e.g., the battery 296 of FIG. 2) which drives the electronic device 510. For example, when the residual quantity of the battery which drives the electronic device 510 is smaller than a reference value (threshold) set in advance in relation to the operation (e.g., activation) of the first condition analysis module 542 or the second condition analysis module 544, the electronic device 510 may restrict the operation of the sub-processor 540 in relation to the first condition analysis module 542.

According to various embodiments, the electronic device 510 may use, for example, a predefined condition stored in the predefined condition database 570, as conditions for displaying a notification through the display 530 functionally connected to the electronic device or automatically executing an application associated with the biometric information. For example, when the condition information (e.g., a heart rate) is included in a first predefined condition (e.g., a heart rate of about less than 120) among predefined conditions stored in the predefined condition database 570, the electronic device 510 may display the notification. Also, when the condition information is included in a second predefined condition (e.g., a heart rate of about 120 or larger) among the predefined conditions stored in the predefined condition database 570, the electronic device 510 may automatically execute the application associated with the biometric information.

According to various embodiments, the electronic device 510 may store, in the memory 580, feedback information (e.g., selection, recommendation, cancellation, or the like) about the associated with the biometric information based on a user input (e.g., a touch, a double touch, a long press, a left/right movement after a touch, a gesture, or a drag and drop). In addition, when the feedback information is selection or recommendation, the electronic device 510 may change (e.g., increase) the importance (e.g., the priority) of an application corresponding to such feedback information.

According to various embodiments, the electronic device 510 may obtain the feedback information using the notification displayed through the display 530 or the application. For example, after the notification is displayed on the display 530, the electronic device 510 may determine, when a user input (e.g., notification deletion) is generated, the user input as the feedback information (e.g., cancellation). In addition, the electronic device 510 may store, in the memory 580, the user input which has been determined as the feedback information. In addition, the electronic device 510 may display a user interface for obtaining the feedback information on the display 530, separately from the notification or the application associated with the biometric information, and receive the feedback information, for example, the evaluation of the notification or the application (e.g., selection, recommendation, cancellation, or the like) through the user interface. The user interface for obtaining the feedback information may include, for example, icons (e.g., buttons) for receiving the input of the feedback information from the user.

According to various embodiments, the electronic device 510 may use, for example, the evaluations of the predefined condition and the application, as conditions for displaying the notification or automatically executing the application associated with the biometric information through the display 530 functionally connected to the electronic device. For example, the electronic device 510 may determine the user's preference or habit using the evaluation of the application, and store the determined preference or habit of the user in the memory 580. When the predefined condition is included in the user's preference or habit stored in the memory 580, the electronic device 510 may automatically execute or recommend the application associated with the biometric information of the user.

According to various embodiments, the electronic device 510 may display the notification or automatically execute the application associated with the biometric information through the display 530 functionally connected to the electronic device, based on user authentication (e.g., password, fingerprint, iris, voice speaker recognition, pattern input for releasing pattern lock, or the like). For example, when the user authentication is performed, the electronic device 510 may store the predefined condition and the application information depending on each user. Thus, when the user authentication is performed again, the electronic device 510 may display the notification or automatically execute the application based on the previously stored predefined condition and application information. In addition, the electronic device may provide personalized services using the predefined condition and the application information for each user.

According to various embodiments, the electronic device 510 may share information stored in the predefined condition database 570 or the memory 580 with the external device 520 and/or the server 590. For example, the electronic device 510 may deliver (transmit) at least a part of the predefined condition stored in the predefined condition database 570 or the feedback information stored in the memory 580 to the external device 520 and/or the server 590 through the network 592. Also, the electronic device 510 may receive the at least a part of the predefined condition or the feedback information from the external device 520 and/or the server 590 through the network 592.

According to various embodiments, the electronic device 510 may transmit, to the external device 520 with respect to the electronic device 510 and/or the server 590, at least a part of the condition information or a representation/notification (e.g., a notification, an indicator, an icon, a widget, or the like) corresponding to the condition information. Also, the at least a part of the condition information or the representation/notification corresponding to the condition information, which has been transmitted to the outside, may be displayed through at least one of the display 532 functionally connected to the external device 520 or the display functionally connected to the server 590.

According to another embodiment, the electronic device 510 may output a sound or generate a vibration or a haptic effect through an audio module and/or a motor (e.g., the motor 298 of FIG. 2), which is functionally connected to the external device 520 and/or the server 590, as at least one of the condition information and the representation/notification corresponding to the condition information. For example, the electronic device 510 may output a sound or a voice through the audio module (e.g., a speaker) of the external device 520 and/or the server 590, as at least one of the representation/notification. Also, the electronic device 510 may generate vibration or haptic effects through the external device 520 and/or the motor or haptic device (e.g., a vibration generation device, a tactile display device, a piezoelectric device, or a Braille display device) of the server 590.

According to various embodiments, the external device 520 may include, for example, the third condition analysis module 546, and the third condition analysis module 546 may perform the same or similar function as or to that of at least one of the first condition analysis module 542 or the second condition analysis module 544. For example, at least a part of the third condition analysis module 546 may be implemented by a processor operated with a relatively lower power than that in a general-purpose processor of the external device. In addition, the external device 520 may obtain the biometric information from the sensor module 562 functionally connected to the external device 520 while using less power based on the third condition analysis module 546, through the processor operated with low power.

According to various embodiments, the electronic device 510 may determine condition information associated with the user using at least one of the third condition analysis module 546 included in the external device 520 and the first condition analysis module 542 or the second condition analysis module 544, which is included in the electronic device 510. For example, the electronic device 510 may obtain the biometric information from the sensor module 562 functionally connected to the external device 520 and the sensor module 560 functionally connected to the electronic device 510, and determine the condition information based on the obtained biometric information. For example, the electronic device 510 may determine the condition information associated with the user as running (state), based on HRM information received from a heart rate sensor (e.g., the biometric sensor 240I of FIG. 2) functionally connected to the external device 520 and acceleration information received from an acceleration sensor (e.g., the acceleration sensor 240E of FIG. 2) functionally connected to the electronic device 510.

In addition, for example, the electronic device 510 may determine the condition information associated with the user as running (state) using the heart rate which is the condition information determined through the third condition analysis module 546 included in the external device 520 and a motion which is the condition information determined through at least one of the first condition analysis module 542 and the second condition analysis module 544 which are included in the electronic device 510.

According to an embodiment, the electronic device 510 may transmit and receive at least one of the biometric information associated with the user and the condition information through the network 592. For example, the electronic device 510 may receive the biometric information obtained from the sensor module 562 functionally connected to the external device 520 through the network 592, or receive the condition information determined using the third condition analysis module 546 included in the external device 520 through the network 592.

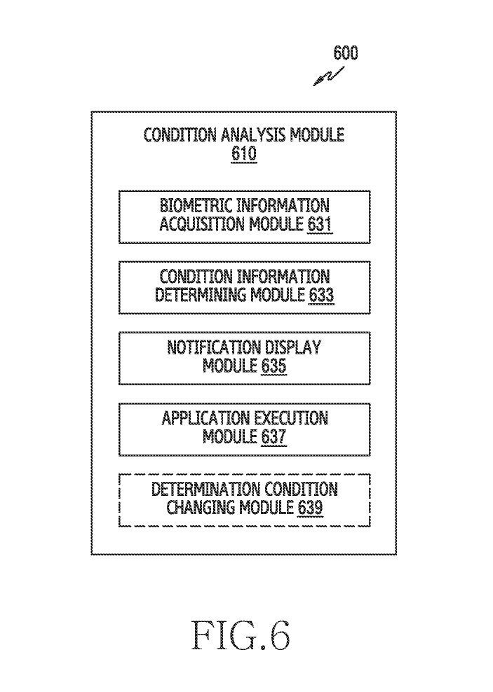

FIG. 6 is a block diagram illustrating a condition analysis module in an electronic device according to various embodiments of the present disclosure.

Referring to FIG. 6, the electronic device 600 may include all or some of the components of the electronic device 101 illustrated in FIG. 1. Hereinafter, descriptions of the same or similar components as or to those in FIGS. 1 to 5 will be omitted.

A condition analysis module 610 (e.g., the condition analysis module 180 of FIG. 1) may include, for example, a biometric information acquisition module 631, a condition information determining module 633, a notification display module 635, and an application execution module 637. In some embodiments, the condition analysis module 610 may omit at least one of the above-described components or additionally include other components.

In FIG. 6, a case in which all components of the condition analysis module 610 are included in a single electronic device (e.g., the electronic device 600) is illustrated, but various embodiments are not limited thereto. For example, at least a part of the condition analysis module 610 may be distributed in the electronic device 600 and an external device (e.g., the first external electronic device 102, the second external electronic device 104, or the server 106 of FIG. 1), and implemented. For example, the biometric information acquisition module 631 and/or the condition information determining module 633 of the condition analysis module 610 may be included in the external device, and the notification display module 635 and/or the application execution module 637 may be included in the electronic device.

According to an embodiment, when the biometric information acquisition module 631 and/or the condition information determining module 633 is included in the external device and the notification display module 635 and/or the application execution module 637 is included in the electronic device, the external device may acquire biometric information associated with a user obtained from a sensor module (e.g., the sensor module 562 of FIG. 5) functionally connected to the electronic device 600 using the biometric information acquisition module 631, and determine condition information associated with the biometric information using the condition information determining module 633. In addition, the external device may transmit at least one of the biometric information and the condition information to the electronic device 600 through a network (e.g., the network 162 of FIG. 1). The electronic device 600 may display at least one of a notification, an application, and another user interface through a display (e.g., the display 532 of FIG. 5) functionally connected to the electronic device based on at least one of the biometric information and the condition information which are received from the external device.

According to various embodiments, the biometric information acquisition module 631 may acquire the biometric information associated with the user through the sensor module functionally connected to the electronic device 600 or the external device. For example, the biometric information acquisition module 631 may acquire a skin moisture ratio of the user through a skin moisture ratio sensor. Also, the biometric information acquisition module 631 may acquire a heart rate of the user through an HRM sensor.

According to various embodiments, the biometric information acquisition module 631 may be implemented as a low power module. For example, the biometric information acquisition module 631 may always (at all times) acquire the biometric information associated with the user while operating with a relatively lower power when prepared for a general-purpose processor of the electronic device 600 or a general-purpose data processing module.

According to various embodiments, the condition information determining module 633 may receive the biometric information associated with the user from the biometric information acquisition module 631, and determine condition information associated with the user in relation to the biometric information. For example, when the biometric information is HRM information, the condition information determining module 633 may determine a condition item associated with the HRM information as a heart rate, and determine a condition value corresponding to the condition item as a value (e.g., about 80 bpm) indicating a heart rate. Also, when the biometric information is acceleration information, the condition information determining module 633 may determine a condition item associated with the acceleration information as a motion, and determine a condition value corresponding to the condition item as a value (e.g., about 4 km/h) indicating a speed. Also, when the biometric information is brain wave information, the condition information determining module 633 may determine a condition item associated with the brain wave information as sleep, and determine a condition value corresponding to the condition item as a value (e.g., about 8 to 13 Hz) indicating a frequency band.

According to various embodiments, the condition information determining module 633 may determine the condition information based on the biometric information associated with the user acquired from each of the electronic device 600 and the external device. For example, when the biometric information acquired from the electronic device 600 is HRM information and the biometric information acquired from the external device is acceleration information, the condition information determining module 633 may determine the condition information associated with the user based on the HRM information and the acceleration information. For example, the condition information determining module 633 may determine the condition item as steps (walking), and determine the condition value corresponding to the condition item as the number of steps (e.g., the number of steps of about 100 or larger/minute).

According to various embodiments, the notification display module 635 or the application execution module 637 may compare the condition information with information (e.g., a predefined condition or feedback information) included in a predefined condition database (e.g., the predefined condition database 570 of FIG. 5) included in the electronic device 600 and/or a memory (e.g., the memory 580 of FIG. 5). In addition, the notification display module 635 or the application execution module 637 may display at least one of the notification, the application, and the other user interface through a display (e.g., the displays 530 and 532 of FIG. 5) functionally connected to the electronic device 600 and/or the external device.

According to various embodiments, when the condition information (e.g., steps (walking)) is a first predefined condition (e.g., a heart rate of about 120 or less and a motion of about 4 km/h or less) included in the predefined condition database, the notification display module 635 may display a notification corresponding to the biometric information (e.g., HRM information and acceleration information) through the display. For example, when the condition information is included in the first predefined condition, the notification display module 635 may display a notification (e.g., a notification, an indicator, an icon, a widget, or the like) corresponding to the biometric information (e.g., HRM or acceleration information) in at least a part (e.g., an upper end or a lower end) of the display. In addition, the notification display module 635 may output a sound or generate a vibration through an audio module (e.g., the audio module 280 of FIG. 2) and/or a motor (e.g., the motor 298 of FIG. 2), which is functionally connected to the electronic device 600.

According to various embodiments, when the condition information is included in the first predefined condition, the notification display module 635 may control an application (e.g., a health application, an SMS/MMS 373, an IM 374, a browser 375, a camera 376, a media player 382, an album 383, or the like) included in the electronic device 600 not to be automatically executed. For example, in a case in which the condition information is steps (walking), the notification display module 635 may control the application included in the electronic device 600 not to be automatically executed while displaying the notification corresponding to the biometric information (e.g., HRM or acceleration information), when the user's heart rate is about 120 or less and the user's motion (e.g., a speed) is about 4 km/h or less.

According to various embodiments, the notification display module 635 may change at least a part of the notification displayed (corresponding to the biometric information) through the display, based on a change in the biometric information (e.g., HRM or acceleration information). For example, when the HRM information is changed while the notification (e.g., a heart rate of about 80) corresponding to the HRM information acquired from the biometric information acquisition module 631 is displayed through the display, the notification display module 635 may display the notification (e.g., a heart rate of about 120) corresponding to the changed HRM information through the display. In addition, the notification display module 635 may display, on the display, the notification (e.g., the step (walking) notification 472 of FIG. 4) corresponding to the HRM information and the acceleration information together with the notification corresponding to the HRM information.

According to various embodiments, when the condition information (e.g., steps (walking)) is a second predefined condition (e.g., a heart rate of about 120 or larger and a motion of about 4 km/h or larger) included in the predefined condition database, the application execution module 637 may automatically execute an application associated with the biometric information (e.g., HRM information and acceleration information). For example, when the condition information is included in the second predefined condition, the application execution module 637 may automatically execute a health application that is the application associated with the biometric information (e.g., HRM or acceleration information), and additionally receive a user input (e.g., feedback) through the executed health application.

According to various embodiments, the application execution module 637 may provide a recommendation associated with the biometric information to the user while automatically executing the application (e.g., the health application, the SMS/MMS 373, the IM 374, the browser 375, the camera 376, the media player 382, the album 383, or the like) included in the electronic device 600. For example, the application execution module 637 may provide a recommendation associated with a skin moisture ratio of the user out of the biometric information while automatically executing the health application among the applications. The recommendation may include at least one of a place (location), a time, foods, or medicines in which the skin moisture ratio can be changed, media or sports preferred by the user, and an action that is required to be taken by the user. In addition, the application execution module 637 may determine condition information associated with a degree of tension of the user, an ambient temperature of the user, or an exercise state of the user using, for example, the skin moisture ratio of the user. Thus, the application execution module 637 may provide information or services associated with at least one of the degree of tension, the ambient temperature, and the exercise state.

According to various embodiments, the application execution module 637 may determine the recommendation further based on other biometric information associated with the user or the condition information associated with the electronic device 600, when providing the recommendation associated with the biometric information to the user.

For example, the application execution module 637 may provide the recommendation associated with the skin moisture ratio, based on the skin moisture ratio that is the biometric information associated with the user and the HRM information that is other biometric information associated with the user. The recommendation based on the skin moisture ratio and the HRM information may include at least one of a place (location), a time, foods, or medicines in which a degree of tension of the user can be changed, media or sports preferred by the user, and an action that is required to be taken by the user, in order to change the skin moisture ratio by changing, for example, the degree of tension of the user.

In addition, the application execution module 637 may provide a recommendation associated with the skin moisture ratio, based on, for example, the skin moisture ratio and a location of the electronic device 600 or a motion (change) which is the condition information associated with the electronic device 600. In addition, the application execution module 637 may provide the recommendation associated with the skin moisture ratio, based on, for example, the skin moisture ratio and the condition information associated with the electronic device 600. The recommendation based on the skin moisture ratio and the condition information associated with the electronic device 600 may include at least one of a place (location), a time, foods, or medicines in which the user's motion (posture) can be changed, media or sports preferred by the user, and an action that is required to be taken by the user, in order to change the skin moisture ratio by changing, for example, the user's motion (posture).

According to an embodiment, the application execution module 637 may use the condition information determined based on the biometric information of the user, as the recommendation associated with the biometric information. For example, the application execution module 637 may execute the media player 382 determined as the application associated with the condition information (e.g., running (state)).

According to various embodiments, the application execution module 637 may determine the recommendation based on the first condition information associated with the user and/or the second condition information associated with the electronic device 600, when providing the recommendation associated with the biometric information to the user. For example, in the case of the skin moisture ratio out of the biometric information associated with the user, the application execution module 637 may determine the recommendation based on sweat associated with the skin moisture ratio, a stress state, an exercise state (e.g., the first condition information), and/or an ambient temperature (e.g., the second condition information) acquired from the electronic device 600, because a value of the skin moisture ratio may be changed due to the stress state of the user, a change in the temperature, or the user's exercise state.

The application execution module 637 may determine the first condition information (e.g., the degree of tension or the stress state) based on, for example, the skin moisture ratio that is the biometric information associated with the user and the HRM information that is other biometric information associated with the user, and provide the recommendation associated with the first condition information based on the first condition information and the second condition information (e.g., the location of the electronic device 600 or the motion (change)) associated with the electronic device 600. The recommendation based on the first condition information and the second condition information may include at least one of a place (location), a time, foods, or medicines in which the user's motion (posture) can be changed, media or sports preferred by the user, and an action that is required to be taken by the user, in order to change the degree of tension of the user or the stress state by changing, for example, the user's motion (posture).

According to various embodiments, the application execution module 637 may determine new condition information (e.g., third condition information) based on a plurality of pieces of condition information (e.g., the first condition information and the second condition information). For example, when a value of the condition information (e.g., the first condition information) associated with the skin moisture ratio is larger than a reference value set in advance in the electronic device and the condition information associated with the skin moisture ratio is included in a condition (e.g., fitness, swimming, running, or the like) predefined as the user's motion (e.g., the second condition information), the application execution module 637 may determine the condition information (e.g., the third condition information) associated with the electronic device 600 to be the exercise state.

For example, when the value of the condition information (e.g., the first condition information) associated with the skin moisture ratio is larger than the reference value set in advance in the electronic device 600 and is included in a temperature (e.g., the second condition information) higher than a temperature set in advance in the electronic device 600 through a temperature sensor (e.g., the temperature/humidity sensor 240J of FIG. 2) functionally connected to the electronic device 600, the application execution module 637 may determine the condition information (e.g., the third condition information) associated with the electronic device 600 to be sweat.

For example, when the value of the condition information (e.g., the first condition information) associated with the skin moisture ratio is larger than the reference value set in advance in the electronic device 600 and is included in a heart rate (e.g., the second condition information) larger than a heart rate set in advance in the electronic device 600 through a heart rate sensor functionally connected to the electronic device 600, the application execution module 637 may determine the condition information (e.g., the third condition information) associated with the electronic device 600 to be the degree of tension or the stress state.

According to various embodiments, the application execution module 637 may change new condition information (e.g., the third condition information) determined based on a plurality of pieces of condition information (e.g., the first condition information and the second condition information). For example, when the value of the condition information (e.g., the first condition information) associated with the skin moisture ratio is larger than the reference value set in advance in the electronic device and is included in a temperature (e.g., the second condition information) higher than a temperature set in advance in the electronic device 600 through the temperature sensor (e.g., the temperature/humidity sensor 240J of FIG. 2) functionally connected to the electronic device 600, the application execution module 637 may determine the condition information (e.g., the third condition information) associated with the electronic device 600 to be sweat. For example, additionally, when a heart rate higher than the heart rate set in advance in the electronic device 600 is measured through the heart rate sensor functionally connected to the electronic device 600, when a user's temperature is high, when the degree of tension of the user is low, or when the user is not in the stress state, the application execution module 637 may change the sweat which is the new condition information (e.g., the third condition information) to a health state of the user, and provide information associated with the health state of the user.

According to various embodiments, when the condition information corresponds to a third predefined condition, the application execution module 637 may provide a recommendation associated with the biometric information to the user. For example, when the condition information is a second predefined condition (e.g., a heart rate of about 120 or larger and a motion of about 4 km/h or larger) included in the predefined condition database, the application execution module 637 may additionally determine whether the corresponding condition information is included in the third predefined condition (e.g., a heart rate of about 160 or larger and a motion of about 8 km/h or larger) without automatically executing the application associated with the biometric information (e.g., HRM information and acceleration information) through the display. When the condition information is the third predefined condition, the electronic device 600 may provide a recommendation associated with the biometric information (e.g., HRM information or acceleration information). The recommendation may be a place (location), a time, foods, or medicines in which the HRM or acceleration information of the user can be changed, media or sports preferred by the user, and an action that is required to be taken by the user.

According to various embodiments, the application execution module 637 may automatically release a lock screen for the electronic device 600, in response to an automatic execution event of a predefined application (e.g., the health application) among applications (e.g., the health application, the SMS/MMS 373, the IM 374, the browser 375, the camera 376, the media player 382, the album 383, or the like) included in the electronic device 600. For example, when the lock screen for the electronic device 600 is set and the condition information determined by the condition information determining module 633 corresponds to the predefined condition, the application execution module 637 may automatically release the lock screen while automatically executing the health application among the applications. Thus, the user may use the health application without an additional user input or action (e.g., fingerprint recognition, iris recognition, or the like) for releasing the lock screen.

According to various embodiments, the application execution module 637 may perform authentication for the user based on the biometric information, as a part of the process of automatically executing the application associated with the biometric information. For example, the application execution module 637 may perform authentication for the user based on the biometric information acquired using the biometric information acquisition module 631 while executing the health application, and determine whether to automatically execute the application based on the authentication. For example, when the authentication for the user does not succeed, the application execution module 637 may display an additional user interface for performing the authentication through the display. The user may perform authentication for the user through the additional user interface. When the authentication succeeds, the application execution module 637 may automatically execute the application associated with the biometric information, that is, the health application.

According to various embodiments, the application execution module 637 may change information displayed through the display in the electronic device 600 according to the authentication for the user, as a part of the process of automatically executing the application associated with the biometric information. For example, when the authentication for the user succeeds while the health application among the applications is executed, the application execution module 637 may display all information (e.g., a heart rate, a momentum, etc.) included in the health application. Also, when the authentication for the user does not succeed, the application execution module 637 may display the smaller number of pieces of information included in the health application than that in the case in which the authentication succeeds. For example, the application execution module 637 may display only a part of the information included in the health application, or display summarized information. Also, when the authentication for the user does not succeed, the application execution module 637 may simultaneously or sequentially display at least a part of the information included in the health application and the lock screen. For example, when the condition information is determined to be running (state) in a state in which the lock screen is displayed through the display, the application execution module 637 may display information (e.g., a pedometer value or a calorie consumption value) having a low direct relevance with the user on at least a part of the display, together with the lock screen.

According to various embodiments, the application execution module 637 may perform the authentication for the user based on characteristics of the biometric information (e.g., an ECG wave form) of the user. For example, the ECG wave form out of the biometric information of the user may represent characteristics associated with a location or a shape of the user's heart. Thus, the application execution module 637 may compare the ECG wave form acquired from the electronic device 600 and an ECG wave form set in advance in the electronic device 600, and determine that the user authentication has succeeded when the ECG wave forms are the same or similar.

According to various embodiments, the application execution module 637 may change (or adjust) the recommendation provided to the user based on at least one of the authentication for the user and a connection state (e.g., a non-connected state, a connected state, during connection, or a connection completion state, or the like) between the electronic device 600 and the external device, as a part of the process of automatically executing the application (or function) associated with the biometric information. For example, when the authentication for the user succeeds while the health application among the applications is executed, the application execution module 637 may change the recommendation provided to the user in real-time. Also, when the authentication for the user does not succeed, the application execution module 637 may not change the recommendation provided to the user, or may not provide the recommendation to the user.

According to an embodiment, the application execution module 637 may change a quantity (e.g., the number of the recommendations, the type of the recommendation, or the like) or a quality (e.g., preference, accuracy, or the like) of the recommendation provided to the user in accordance with the connection state between the electronic device 600 and the external device. For example, when the electronic device 600 is in a non-connected state with the external device, the application execution module 637 may provide only the recommendation associated with the electronic device 600, and when the electronic device 600 is in a connection completion state with the external device, the application execution module 637 may provide the recommendation associated with the electronic device 600 and the external device.

According to various embodiments, the application execution module 637 may simultaneously or sequentially display notifications corresponding to the biometric information on the display, as a part of the process of automatically executing the application associated with the biometric information. For example, when the first predefined condition is changed to the second predefined condition, the application execution module 637 may maintain or change the notification corresponding to the biometric information, which is displayed on the display by the notification display module 635 in the first predefined condition.

According to an embodiment, when the first predefined condition is changed to the second predefined condition, the application execution module 637 may automatically execute the application associated with the biometric information while maintaining or changing the notification (e.g., a sound or a vibration) displayed by the notification display module 635.

According to various embodiments, the condition analysis module 610 may determine whether one or more pieces of additional condition information is acquired based on at least one of the condition information (e.g., sweat, a heart rate, a degree of tension, etc.). For example, when information about the degree of tension out of the condition information associated with the user is the same as or similar to information included in the predefined condition database (e.g., the predefined condition database 570 of FIG. 5) and/or the memory (e.g., the memory 580 of FIG. 5), the condition analysis module 610 may acquire one or more pieces of additional condition information (e.g., a motion, a posture, a time, a location, a movement distance, sleep, awakening, etc.) associated with the user. The condition analysis module 610 may display at least one of the notification, the application, and the other user interface based on the additional condition information.

According to various embodiments, the condition analysis module 610 may display at least one of the notification, the application, and the other user interface through the display (e.g., the displays 530 and 532 of FIG. 5) functionally connected to the electronic device 600 and/or the external device using the predefined condition database (e.g., the predefined condition database 570 of FIG. 5) and/or the memory (e.g., the memory 580 of FIG. 5), which is included in the electronic device 600. For example, the condition analysis module 610 may compare the biometric information acquired through the biometric information acquisition module 631 with the predefined condition included in the predefined condition database and/or the feedback information (e.g., selection, recommendation, cancellation, or the like) included in the memory, and display at least one of the notification, the application, and the other user interface.

According to various embodiments, the condition analysis module 610 may further include a determination condition changing module 639 other than, the above-described components, for example, the biometric information acquisition module 631, the condition information determining module 633, the notification display module 635, and the application execution module 637. For example, the condition analysis module 610 may include the biometric information acquisition module 631, the condition information determining module 633, the notification display module 635, the application execution module 637, the determination condition changing module 639, or include only the determination condition changing module 639.

According to various embodiments, the determination condition changing module 639 may access the predefined condition database and/or the memory, which is included in the electronic device 600, and change the information (e.g., the predefined condition or the feedback information) included in the predefined condition database and/or the memory. For example, the determination condition changing module 639 may change the predefined condition included in the predefined condition database based on the condition information, and change the feedback information included in the memory based on the user input. In addition, the determination condition changing module 639 may change the feedback information based on the condition information, and change the predefined condition based on the user input.

According to various embodiments, when the electronic device 600 includes a plurality of condition analysis modules, the determination condition changing module 639 may control the functions or priorities of the plurality of condition analysis modules that access the predefined condition database and/or the memory, which is included in the electronic device 600. For example, the determination condition changing module 639 may control (access) the predefined condition database through the first condition analysis module (e.g., the first condition analysis module 542 of FIG. 5) among the plurality of condition analysis modules, and control (access) the memory through the second condition analysis module (e.g., the second condition analysis module 544 of FIG. 5). Also, the determination condition changing module 639 may control the first condition analysis module rather than the second condition analysis module to first access at least one of the predefined condition database and/or the memory.

According to various embodiments, the determination condition changing module 639 may be included in at least one of the plurality of condition analysis modules. For example, the determination condition changing module 639 may be included in, for example, the first condition analysis module among the plurality of condition analysis modules, and thereby control operations of the other condition analysis modules, for example, the operation of the second condition analysis module. Also, the determination condition changing module 639 may be included in the second condition analysis module, and thereby control the operation of the first condition analysis module. Other embodiments are also possible.

According to various embodiments, the determination condition changing module 639 may control the operation of one or more modules among the biometric information acquisition module 631, the condition information determining module 633, the notification display module 635, and the application execution module 637 based on the predefined condition and/or the feedback information, which is changed by the determination condition changing module 639. For example, when the predefined condition and/or the feedback information is changed by the determination condition changing module 639, the determination condition changing module 639 may drive at least one of the biometric information acquisition module 631, the condition information determining module 633, the notification display module 635, and the application execution module 637. Thus, in response to the change in the predefined condition and/or the feedback information, the electronic device 600 may acquire the biometric information associated with the user, determine the condition information associated with the user, display the notification corresponding to the biometric information through the display, or automatically execute the application associated with the biometric information.

According to various embodiments, the electronic device may include a sensor that receives information associated with at least one of a user and an ambient environment from the outside, and a processor-implemented condition analysis module that is functionally connected to the sensor. Here, the condition analysis module may be set to obtain the biometric information associated with the user of the electronic device, determine the condition information associated with the user, display the notification corresponding to the biometric information through the display functionally connected to the electronic device when the condition information corresponds to the first predefined condition, and automatically execute the application associated with the biometric information when the condition information corresponding to the second predefined condition.

According to various embodiments, the condition analysis module is set to obtain the biometric information associated with the user through a processor corresponding to a low power module functionally connected to the electronic device.

According to various embodiments, the condition analysis module may be set to determine at least one of a sleep state, a motion state, a health state, and an emotional state of the user as at least a part of the condition, based on at least the biometric information.

According to various embodiments, the condition analysis module may be set to change at least a part of the notification based on the biometric information.

According to various embodiments, the condition analysis module may be set to change a scheme in which the corresponding data is output from the electronic device associated with the notification to the outside, a color, luminosity, transparency, a display position, a size, a content displayed in the at least a part of the notification, or a visual effect of the content, based on at least the condition.

According to various embodiments, the condition analysis module may be set to execute authentication for the user based on at least the biometric information.

According to various embodiments, the condition analysis module may be set to change (or adjust) a recommendation provided to the user, based on at least one of the authentication for the user and a connection state between the electronic device and an external device.

According to various embodiments, the condition analysis module may be set to determine whether to obtain one or more pieces of additional (new) condition information based on at least the condition information.

According to various embodiments, the condition analysis module may be set to change the predefined condition based on at least one of the condition information and a user's input.

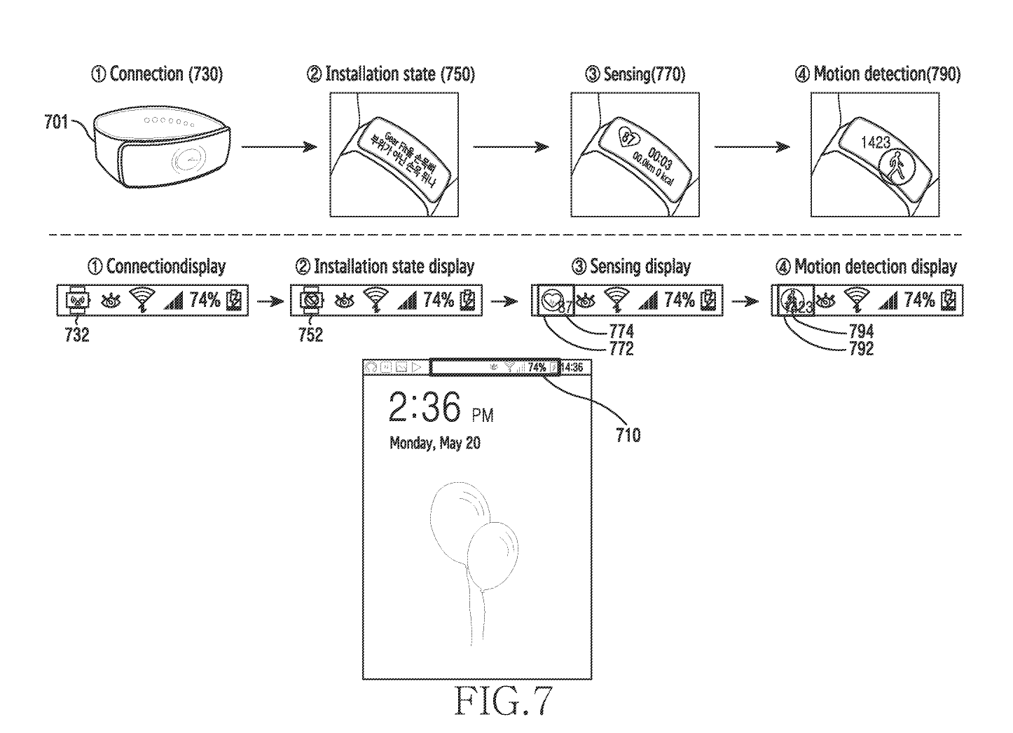

FIG. 7 illustrates an example in which a user interface for providing a notification corresponding to user biometric information is applied in an electronic device according to various embodiments of the present disclosure.

Referring to FIG. 7, an electronic device (e.g., the electronic device 101) may display a notification display user interface 710 in at least a part of a display (e.g., the display 160 of FIG. 1) that is functionally connected to the electronic device. The notification display user interface 710 may be always displayed in the electronic device. The notification display user interface 710 may or may not be displayed based on a user input. In addition, the notification display user interface 710 may be displayed through, for example, a notification manager (e.g., the notification manager 349 of FIG. 3) included in the electronic device. In addition, the electronic device may display at least one of a connection notification 732, an installation (wear) notification 752, a biometric information notification 772, a movement (motion) notification 792, and an emotional state notification (not shown) through the display. In addition, the electronic device may display at least one of a time notification (e.g., an administration time notification) associated with the user biometric information and a location notification (e.g., a fitness center, a playground, a home, etc.) through the display in the notification display user interface 710.

According to various embodiments, the electronic device may provide, to a user, notification information (e.g., the connection notification 732) associated with a communication connection with an external device 701 (e.g., the electronic devices 102 and 104) through the notification display user interface 710, and receive a user input associated with the provided notification information. For example, the electronic device may receive a request for a communication connection with the electronic device from the external device 701, and indicate a communication connection state 730 with the external device 701 based on the request for the communication connection. In addition, a notification (e.g., the connection notification 732) indicating the communication connection state 730 may be displayed through the notification display user interface 710 included in the display. In addition, the electronic device may change the display of the notification indicating the communication connection state 730 that is the connection notification 732 according to the communication connection state 730 (e.g., signal strength) with the external device 701. For example, when the signal strength between the electronic device and the external device 701 is higher (e.g., strong) than a reference value (threshold) set in advance in relation to the communication connection, the brightness of a color displayed on the connection notification 732 may be made high, or an icon (e.g., an arrow) indicating the connection may be displayed. Also, when the signal strength is lower (e.g., weak) than the reference value (threshold) set in advance in relation to the communication connection, the brightness of the color displayed on the connection notification 732 may be made low, or the icon indicating the connection may not be displayed. Also, the electronic device may display the connection notification 732 on the display functionally connected to the external device 701, or represent the connection notification 732 as a sound, a vibration, or a haptic effect through the audio module, the motor, or the haptic device, which is functionally connected to the external device 701.

According to various embodiments, the electronic device may provide, to the user, notification information (e.g., an installation (wear) state notification 752) associated with an installation (wear) state 750 between the user and the external device 701 through the notification display user interface 710, and receive a user input associated with the provided notification information. For example, the electronic device may receive, from the external device 701, information (e.g., a contact area, a degree of proximity between a sensor and the user's skin, a contact state between a lead (electrode) of an ECG and the skin, a quantity of light of reflected light received through a PPG sensor-direct-current (DC)/alternating current (AC) or pattern information, or the like) indicating a degree of contact between the user's skin and the external device 701, and the degree of contact may indicate the installation (wear) state 750 between the user and the external device 701.

According to various embodiments, the electronic device may display the installation (wear) state notification 752 in the notification display user interface 710 based on the installation (wear) state 750 received from the external device 701. In the installation (wear) state notification 752, the information (e.g., a contact area, a degree of proximity between a sensor and the user's skin, a contact state between a lead (electrode) of an ECG and the skin, a quantity of light of reflected light received through a PPG sensor-DC/AC or pattern information, or the like) indicating a degree of contact between the user's skin and the external device 701 included in the installation (wear) state 750 may be displayed as at least one of a text, an image, an icon, and a widget. In addition, when the contact area of the installation (wear) state is wider than a contact area (e.g., about 2 cm²) set in advance in the electronic device (e.g., when the contact area is large), the electronic device may display the installation (wear) state notification 752 through the display, and when the contact area of the installation (wear) state is not wider than the contact area (e.g., about 2 cm²) set in advance in the electronic device (e.g., when the contact area is small), the electronic device may output a sound through the audio module (e.g., the audio module 280 of FIG. 2) functionally connected to the electronic device, as at least a part of the installation (wear) state notification 752.

According to another embodiment, the electronic device may use a variety of sensors functionally connected to the electronic device when determining the installation (wear) state 750 received from the external device 701, and display the installation (wear) state notification 752 in the notification display user interface 710 based on the installation (wear) state 750 received from the external device 701. For example, the electronic device may determine the installation (wear) state 750 using the ECG sensor functionally connected to the electronic device. The ECG sensor may include a plurality of leads (electrodes), and measure an ECG of the user when the user's body (e.g., a hand, a finger, a foot, or the like) is in contact with each of the leads. Based on this, the electronic device may determine the installation (wear) state 750, and display the determined installation (wear) state 750 through the display functionally connected to the electronic device or represent the installation (wear) state notification 752 using at least one of the audio module, the motor, and the haptic device.

According to various embodiments, the electronic device may determine, for example, the installation (wear) state 750 using the PPG sensor functionally connected to the electronic device. The PPG sensor may measure a heart rate of the user, an oxygen saturation, or HRV information, and reflected light information that reflects the expansion of blood vessels below the user's skin and the oxygen saturation of blood may be changed according to a degree in which the PPG sensor is adhered to the user's skin (e.g., a degree of proximity or a degree of adhesion). For example, the PPG sensor may detect a DC component that reflects an absolute amount of light received by the PPG sensor and an AC component that reflects a change in biometric signals, through the reflected light information. For example, when the degree of proximity or adhesion between a body (e.g., the user's body) and a sensor is lower than a reference value set in advance in the electronic device, a noise may occur due to the weak intensity of the reflected light or ambient light generated when the reflected light information is received. In contrast, for example, when the degree of proximity or adhesion between a body (e.g., the user's body) and a sensor is higher than the reference value set in advance in the electronic device, the expansion and contraction of user's blood vessels are not smoothly performed, and therefore a change in the AC component is reduced, resulting in causing difficulties in the accurate measurement of the installation (wear) state 750. Thus, when the DC component having a predefined value (e.g., a level) or larger (e.g., 60% or more of a maximum value of a light reception amount) and the AC component having a predefined variation or larger (e.g., the variation between a maximum value and a minimum value of the AC component values is 5% or more of a maximum light reception amount) are detected in the PPG sensor, the electronic device may determine that it is possible to acquire the biometric information (e.g., biometric signal detection) associated with the user. Based on this, the electronic device may measure the installation (wear) state 750. The electronic device may display the installation (wear) state notification 752 through the display functionally connected to the electronic device based on the installation (wear) state 750, or represent the installation (wear) state notification 752 using at least one of the audio module, the motor, and the haptic device.

According to various embodiments, the electronic device may determine the installation (wear) state 750 using, for example, an optical temperature sensor functionally connected to the electronic device. The optical temperature sensor may use a proximity sensor (e.g., the proximity sensor 240G of FIG. 2) included in the electronic device, and determine that it is possible to acquire the biometric information (e.g., biometric signal detection) associated with the user when a distance between the optical temperature sensor and the user's skin is within a range (e.g., within about 2 to 3 cm) set in advance in the electronic device. Based on this, the electronic device may measure the installation (wear) state 750. The electronic device may display the installation (wear) state notification 752 through the display functionally connected to the electronic device, or represent the installation (wear) state notification 752 using at least one of the audio module, the motor, and the haptic device.

According to various embodiments, the electronic device may provide, to the user, notification information (e.g., the biometric information notification 772) associated with biometric information 770 associated with the user through the notification display user interface 710, and receive a user input associated with the provided notification information. For example, the electronic device may receive the biometric information 770 associated with the user, which has been acquired through the sensor module (e.g., the sensor module 562 of FIG. 5) functionally connected to the external device 701. The electronic device may display the biometric information notification 772 associated with the biometric information 770 acquired from the external device 701, through the user interface 710. The biometric information notification 772 may display a numerical value (a value) indicating the biometric information 770 as at least one of a text, an image, an icon, and a widget.

In addition, when a plurality of pieces of the biometric information 770 associated with the user are provided, the electronic device may simultaneously or sequentially display each of the plurality of pieces of the biometric information 770 through the notification display user interface 710. For example, when the biometric information associated with the user is a skin moisture ratio and HRM information, the electronic device may display the skin moisture ratio and the HRM information as a single biometric information notification, or display each of the skin moisture ratio and the HRM information as a plurality of biometric information notifications. In addition, the electronic device may simultaneously or sequentially display the plurality of pieces of biometric information through the biometric information notification 772. In addition, the biometric information notification 772 may include a value 774 (e.g., the HRM information) corresponding to the biometric information 770 associated with the user.

According to various embodiments, the electronic device may provide, to the user, notification information (e.g., the movement (motion) notification 792) associated with movement (motion) information 790 (e.g., walking or running) of the user through the notification display user interface 710, and receive a user input associated with the provided notification information. For example, the electronic device may receive the movement (motion) information 790 determined through the condition analysis module (e.g., the third condition analysis module 546 of FIG. 5) included in the external device 701, or determine the movement (motion) information 790 through the condition analysis module (e.g., the first condition analysis module 542 or the second condition analysis module 544 of FIG. 5) included in the electronic device.

The electronic device may display the movement (motion) notification 792 associated with the movement (motion) information 790 through the notification display user interface 710. The movement (motion) notification 792 may be displayed as at least one of a text, an image, an icon, and a widget, which indicates the movement (motion) information 790, or provide a recommendation associated with the movement (motion) information 790 simultaneously or sequentially with the movement (motion) notification 792. The recommendation may include an application (e.g., the health application, the media player 382, exercise friends, a communication application, or the like) associated with the movement (motion) information 790. The movement (motion) notification 792 may include, for example, a value 794 (e.g., the number of steps) corresponding to the movement (motion) information 790 of the user.

According to various embodiments, the electronic device may display notification information associated with a user's emotional state (e.g., joy, sadness, surprise, arousal, anger, or the like) through the notification display user interface 710. For example, the electronic device may display an index (e.g., a ratio to emotion stage/emotion maximum stage or maximum value) corresponding to the emotional state of the user using a value of HRV information out of the biometric information associated with the user, through the notification display user interface 710.

According to various embodiments, the electronic device may display at least a part of the connection notification 732, the installation (wear) notification 752, the biometric information notification 772, the movement (motion) notification 792, and the emotional state notification (not shown) through the notification display user interface 710. For example, the electronic device may simultaneously or sequentially the installation (wear) notification 752 and/or the biometric information notification 772. In addition, the electronic device may display the movement (motion) notification 792 through the notification display user interface 710 in the same manner as that in the installation (wear) notification 752 and/or the biometric information notification 772.

According to various embodiments, the electronic device may display at least a part of the connection notification 732, the installation (wear) notification 752, the biometric information notification 772, the movement (motion) notification 792, and the emotional state notification (not shown) through the display functionally connected to the external device 701. For example, the electronic device may display the corresponding notification through the display included in the external device 701, or display the corresponding notification by outputting a sound (e.g., audio or voice) or generating a vibration through the audio module or the motor, which is functionally connected to the external device 701. In addition, the electronic device may display the corresponding notification using at least one of a vibration, a frictional force, and a force feedback through the haptic device functionally connected to the external device 701.

According to various embodiments, the electronic device may display the connection notification 732, the installation (wear) notification 752, the biometric information notification 772, the movement (motion) notification 792, or the emotional state notification (not shown), as at least one of a text, an image, an icon, and a widget, or display the corresponding notification as a sound or a vibration through the audio module or the motor (e.g., the motor 298 of FIG. 2) functionally connected to the electronic device. In addition, the electronic device may change a scheme in which the corresponding data is output to the outside from the electronic device associated with the notification (e.g., the connection notification 732, the installation (wear) notification 752, the biometric information notification 772, the movement (motion) notification 792, or the emotional state notification (not shown)), a color, luminosity, transparency, a display position, a size, a content displayed in the at least a part of the notification, or a visual effect of the content.

According to various embodiments, the electronic device may transmit notification information associated with at least one of the connection notification 732, the installation (wear) notification 752, the biometric information notification 772, the movement (motion) notification 792, or the emotional state notification (not shown) to the external device 701 through the network. For example, the electronic device may transmit the notification information to the external device 701, and the external device 701 may display the notification information received from the electronic device, through the display (e.g., the display 532 of FIG. 5) functionally connected to the external device 701 in the same or different representation as or from the notification representation (e.g., the connection notification 732, the installation (wear) notification 752, the biometric information notification 772, the movement (motion) notification 792, or the emotional state notification (not shown)) of the electronic device.

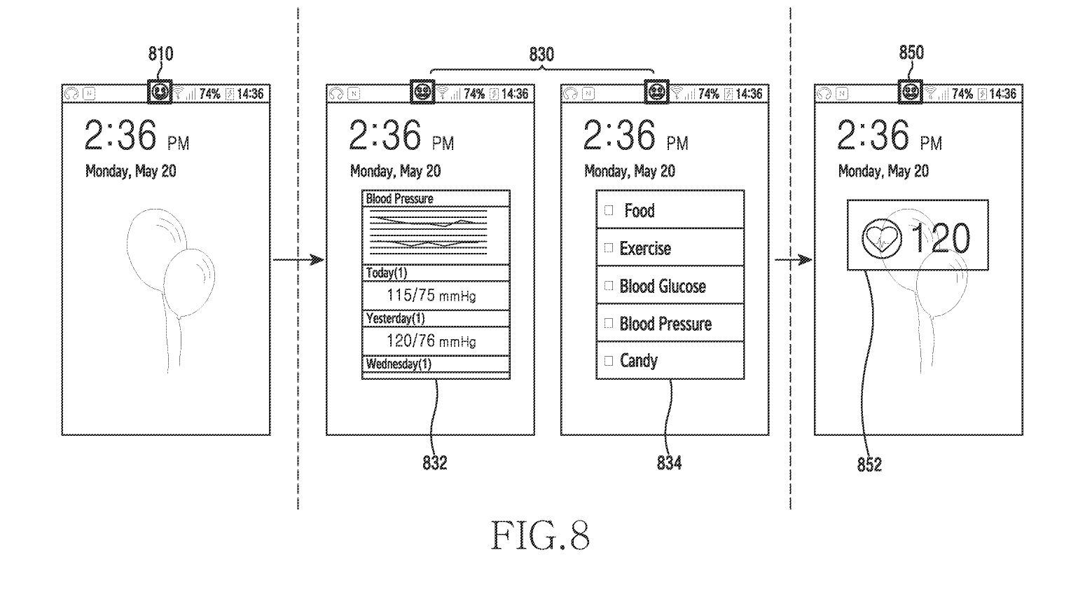

FIG. 8 illustrates an example in which a user interface for changing and/or providing a notification corresponding to user biometric information is applied in an electronic device according to various embodiments of the present disclosure.

Referring to FIG. 8, the electronic device (e.g., the electronic device 101) may display notifications 810, 830, and 850 corresponding to the user biometric information in at least a part of a display (e.g., the display 160 of FIG. 1) functionally connected to the electronic device. In addition, the electronic device (e.g., the electronic device 101) may display notifications 832, 834, and 852 corresponding to details (e.g., a value or a type of biometric information) of biometric information associated with the user, additionally or alternatively on the notification corresponding to the biometric information associated with the user. In general, the electronic device (e.g., the electronic device 101) may display the notifications 832, 834, and 852 corresponding to the details of the user biometric information in response to a user's input with respect to the notifications 810, 830, and 850 corresponding to the biometric information associated with the user, but this is merely an example, and other embodiments are also possible.

According to various embodiments, the notifications 832, 834, and 852 corresponding to the details of the user biometric information may provide the same or similar notifications as or to the notifications 810, 830, and 850 corresponding to the user biometric information. For example, the notifications 810, 830, and 850 corresponding to the user biometric information and the notifications 832, 834, and 852 corresponding to the details of the user biometric information may be displayed on the display based on the same or similar condition information associated with the user.

Hereinafter, for convenience of description, the notifications 810, 830, and 850 corresponding to the user biometric information may be referred to as biometric information notifications, and the notifications 832, 834, and 852 corresponding to the details of the user biometric information may be referred to as biometric information detailed notifications. In addition, the biometric information notifications 810, 830, and 850 may include at least one of the first biometric information notification 810, the second biometric information notification 830, and the third biometric information notification 850, and the biometric information detailed notifications may include at least one of the first biometric information detailed notification 832, the second biometric information detailed notification 834, and the third biometric information detailed notification 852.

According to various embodiments, the electronic device may display the first biometric information notification 810 associated with the biometric information acquired from the user on the display, and the first biometric information notification 810 may indicate a body condition of the user. For example, the electronic device may acquire a skin moisture ratio of the user from a sensor module functionally connected to the electronic device, and determine, as sweat, condition information (a condition item of the condition information) associated with the user based on the skin moisture ratio. Thus, the electronic device may display the first biometric information notification 810 on the display using the skin moisture ratio and information (e.g., a predefined condition or feedback information) included in a predefined condition database and/or a memory, which is included in the electronic device. The first biometric information notification 810 may display a notification corresponding to the skin moisture ratio that is the biometric information of the user, and the first biometric information notification 810 associated with the skin moisture ratio and/or the sweat may simultaneously or sequentially display an icon and/or image indicating a human face and a waterdrop icon and/or an image indicating the sweat.

According to various embodiments, the electronic device may acquire the biometric information associated with the user in addition to the biometric information, and display the second biometric information notification on the display based on a plurality of pieces of biometric information. For example, the electronic device may display a notification different from the first biometric information notification, as the second biometric information notification 830.

According to an embodiment, the electronic device may acquire the plurality of pieces of biometric information (e.g., the skin moisture ratio and HRM information) using the sensor module. The electronic device may display the second biometric information notification 830 different from the first biometric information notification 810 on the display based on the acquired plurality of pieces of biometric information, and display notifications corresponding to the skin moisture ratio of the user and the HRM information which are the plurality of pieces of biometric information. For example, the electronic device may display an icon and/or an image indicating an emotion (e.g., surprise, sadness, joy, or anger) of a person as the second biometric information notification 830.

According to various embodiments, the electronic device may simultaneously or sequentially display the second biometric information notification 830 and the first biometric information detailed notification 832 and/or the second biometric information detailed notification 834 associated with the biometric information of the user. For example, the electronic device may display the second biometric information notification 830 in an upper or lower end of the display, and display the first biometric information detailed notification 832 and/or the second biometric information detailed notification 834 in a middle portion of the display. Each of the first biometric information detailed notification 832 and/or the second biometric information detailed notification 834 may have a size equal to or larger than that of the second biometric information notification 830. In addition, the first biometric information detailed notification 832 may include an application (e.g., a health application) associated with the user biometric information, and the second biometric information detailed notification 834 may include a recommendation associated with the user biometric information or a recommendation corresponding to the application associated with the user biometric information. The electronic device may include foods, sports, or a location (place) capable of changing the user biometric information as the recommendation associated with the user biometric information, and provide another application (e.g., automatically execute the other application) similar to the application as the recommendation corresponding to the application associated with the user biometric information.

According to various embodiments, the electronic device may display the third biometric information notification 850 based on the information (e.g., the predefined condition or the feedback information) included in the predefined condition database (e.g., the predefined condition database 570 of FIG. 5) and/or the memory (e.g., the memory 580 of FIG. 5), while the first biometric information notification 810 or the second biometric information notification 830 is displayed through the display. The third biometric information notification 850 may be different from the first biometric information notification 810 or the second biometric information notification 830. For example, the electronic device may acquire the biometric information associated with the user, and determine condition information based on the acquired biometric information. The electronic device may display the first and second biometric information notifications 810 and 830 on the display using a predefined condition in which the condition information is included in the predefined condition database and/or the feedback information included in the memory.

In addition, the electronic device may change the predefined condition and/or the feedback information while the first and second biometric information notifications 810 and 830 are displayed on the display. The predefined condition and/or the feedback information may be changed based on at least one of the first and second biometric information notifications 810 and 830. For example, the electronic device may receive a user input through a user interface displayed through the display, and change the predefined condition and/or the feedback information using a numerical value (a value) received through the user input or the condition information. In addition, when the first and second biometric information notifications 810 and 830 indicate a specified state (e.g., a degree of tension) of the user, the electronic device may change a numerical value (a value) of the predefined condition and/or the feedback information, the condition information, or a reference value that is a reference of whether the corresponding condition is included in the predefined condition.

The electronic device may display the third biometric information notification 850 as an icon and/or an image different from the first and second biometric information notifications 810 and 830 based on the changed predefined condition and/or the feedback information. Unlike this, for example, when the predefined condition and/or the feedback information is not changed, the electronic device may display the third biometric information notification 850 as the same or similar icon and/or image as or to the first and second biometric information notifications 810 and 830.

According to various embodiments, the electronic device may display the third biometric information detailed notification 852 associated with the user biometric information simultaneously or sequentially with the third biometric information notification 850. For example, the electronic device may display the third biometric information detailed notification 852 using the predefined condition and/or the feedback information, which has been changed based on the user input and/or the first and second biometric information notifications 810 and 830. The third biometric information detailed notification 852 may include, for example, the skin moisture ratio and/or the HRM information out of the biometric information associated with the user. For example, the electronic device may display at least one of a text and a widget indicating the skin moisture ratio and/or the HRM information on the display, simultaneously or sequentially with the icon and/or the image included in the third biometric information notification 850.

In addition, the third biometric information notification 850 and the third biometric information detailed notification 852 may be displayed based on, for example, different biometric information. For example, the third biometric information notification 850 may provide notification information about the skin moisture ratio, and the third biometric information detailed notification 852 may provide notification information about the HRM information. In addition, the electronic device may output a sound (a warning sound) or a vibration through the audio module or the motor, which is functionally connected to the electronic device, so that the user may recognize the third biometric information notification 850 while the third biometric information notification 850 is displayed on the display.

According to various embodiments, the electronic device may display the third biometric information detailed notification 852 based on the change in the predefined condition and/or the feedback information. For example, the electronic device may display at least one of a text and a widget displayed on the third biometric information detailed notification 852 in the same or similar manner as that in the icon and/or the image included in the third biometric information notification 850.

According to various embodiments, the electronic device may change a scheme in which the corresponding data is output to the outside from the electronic device associated with the notification (e.g., the first biometric information notification 810, the second biometric information notification 830, the third biometric information notification 850, the first biometric information detailed notification 832, the second biometric information detailed notification 834, and the third biometric information detailed notification 852), a color, luminosity, transparency, a display position, a size, a content displayed in the at least a part of the notification, or a visual effect of the content.

FIG. 9 illustrates an example in which a user interface for providing a notification and/or an application corresponding to user biometric information is applied in an electronic device according to various embodiments of the present disclosure.

Referring to FIG. 9, the electronic device (e.g., the electronic device 101) may display, for example, notifications 920, 930, 932, 940, 942, 944, 950, 952, 954, and 956 corresponding to user biometric information and/or an application 960 associated with the biometric information in at least a part of a display (e.g., the display 160 of FIG. 1) functionally connected to the electronic device. In addition, notifications corresponding to the user biometric information may include, for example, at least one of sleep notifications 920 and 930, administration notifications 940, 942, and 944, weather notifications 932 and 952, an exercise notification 950, and recommendation notifications 954 and 956, and may be displayed on a notification display user interface 910 that is at least a part of the display. In addition, the notification corresponding to the user biometric information may use, for example, a plurality of pieces of biometric information, and include a notification (e.g., the step (walking) notification 472 of FIG. 4) using the plurality of pieces of biometric information. In addition, the sleep notifications 920 and 930 may include at least one of the first sleep notification 920 and the second sleep notification 930. In addition, the administration notifications 940, 942, and 944 may include, for example, at least one of the first administration notification 940, the second administration notification 942, and the third administration notification 944.

According to various embodiments, the electronic device may display the sleep notifications 920 and 930 indicating a sleep state of the user, and change a schedule (e.g., a calendar schedule or an exercise schedule) associated with the user and/or the setting of the electronic device while the sleep notifications 920 and 930 are displayed. For example, the electronic device may acquire biometric information (e.g., HRM information or brain wave information) of the user through a sensor module (e.g., the sensor module 240 of FIG. 1) functionally connected to the electronic device and/or the external device, and determine condition information (e.g., sleep or awakening) of the user based on the acquired biometric information. When the condition information is sleep, the electronic device may display the sleep notifications 920 and 930 as a notification corresponding to the biometric information. For example, the first sleep notification 920 among the sleep notifications 920 and 930 may indicate that the user is in a sleep state, and may be acquired using at least one of an acceleration sensor, an EEG sensor, a breathing sensor, and a heart rate sensor, which are functionally connected to the electronic device. In addition, the second sleep notification 930 may indicate a degree of deep sleep, and when it is determined that the user is in an awakening state (e.g., arousal state) using the sensor (e.g., a biometric sensor or a movement sensor) functionally connected to the electronic device, the second sleep notification 930 may be displayed through the display. The sleep notifications 920 and 930 may be displayed as at least one of a text, an image, an icon, and a widget, which indicates a sleep state of the user. For example, the sleep notifications 920 and 930 may include a moon-like (e.g., a moon shape) image and/or an icon indicating the night.

In addition, the electronic device may change the schedule associated with the user and/or the setting of the electronic device while the sleep notifications 920 and 930 are displayed. For example, the electronic device may provide or recommend another schedule in addition to the schedule associated with the user when it is determined that the sleep state of the user is excellent (e.g., a sleep time of about 7 hours or more). When it is determined that the sleep state of the user is poor (e.g., a sleep time of about 7 hours or less or a ratio of a deep sleep to the whole sleep being about 70% or less), the electronic device may omit at least a part of the schedule associated with the user. Alternatively, the electronic device may change information (e.g., a momentum, an exercise place, a food-related place, or a type of exercise) included in the schedule.

According to an embodiment, the electronic device may change an acquisition period of the biometric information acquired from the sensor module, a notification period displayed in the electronic device, a sound volume, or a vibration amplitude. For example, when it is determined that the sleep state of the user is poor, the user's response to the notification may be slow or the user may be insensitive to external simulation, and therefore it is possible to improve user's attention (e.g., recognition) to the notification by changing the notification period, the sound volume, or the vibration amplitude, which is displayed in the electronic device. In addition, for example, when it is determined that the user's sleep state is poor (e.g., a sleep time being about 7 hours or less or a ratio of a deep sleep to the whole sleep being about 70% or less), the electronic device may change the acquisition period of the biometric information to be shorter (e.g., 20 times/one hour) than a default value (e.g., 10 times/one hour). For example, the electronic device may acquire a larger amount of the biometric information associated with a health state of the user by changing the acquisition period of the biometric information acquired from the sensor module. For example, the electronic device may provide a notification, a service, or a recommendation associated with the health state of the user through the display.

According to various embodiments, the electronic device may display the weather notifications 932 and 952 on the display, simultaneously or sequentially with the sleep notifications 920 and 930. For example, the electronic device may display the weather notifications 932 and 952 based on information received through a sensor (e.g., the atmospheric pressure sensor 240C, the temperature/humidity sensor 240J, the luminance sensor 240K, or the UV sensor 240M) associated with the weather notifications 932 and 952 among the sensor modules and/or a network (e.g., the network 162 of FIG. 1). In addition, the electronic device may display the weather notifications 932 and 952 simultaneously or sequentially with the sleep notifications 920 and 930, and change the schedule associated with the user and/or the setting of the electronic device using the weather notifications 932 and 952. For example, when the outdoor temperature is higher than (e.g., about 30 degrees or higher) a reference temperature set in advance in the electronic device, the electronic device may omit or change (e.g., change the corresponding schedule to indoor sports or treadmill) the schedule (e.g., outdoor sports or hiking) associated with the user. Alternatively, the electronic device may recommend at least one of information associated with the changed schedule (e.g., indoor sports or treadmill) and stretching. In addition, when the outdoor temperature is lower than (e.g., about 30 degrees or lower) the reference temperature set in advance in the electronic device, the electronic device may change the information (e.g., a momentum or a type of exercise) included in the schedule.

According to various embodiments, the electronic device may display the administration notifications 940, 942, and 944 associated with a medicine which the user must take. For example, the electronic device may acquire personal information (e.g., a calendar schedule, a medication, a surgical history, a height, an age, or a body weight, etc.) of the user while acquiring the biometric information associated with the user. The personal information may be included in the predefined condition or the feedback information. The electronic device may display the administration notifications 940, 942, and 944 associated with the medicine which the user must take using the personal information and the biometric information.

According to an embodiment, when displaying the administration notifications 940, 942, and 944, the electronic device may change a color, an image, or an icon displayed in the administration notifications 940, 942, and 944, and output the administration notifications 940, 942, and 944 using the audio module or the motor functionally connected to the electronic device, so that the user can recognize the medicine which the user must take. For example, the electronic device may determine the user's medication and/or a medication time using the personal information, and provide information associated with the medication and/or a medication time through the color displayed in the administration notifications 940, 942, and 944 or the vibration output from the electronic device. When an error of the medication time of the user is smaller than a reference time (e.g., within ±30 minutes of an error range) set in advance in the electronic device, the electronic device may display the first administration notification 940, and output a weak vibration of the electronic device. In addition, when the error of the medication time of the user is larger than the reference time (e.g., within about +1 hour of the error range) set in advance in the electronic device, the electronic device may display the second administration notification 942, and output a strong vibration of the electronic device. In addition, when the error of the medication time of the user is significantly larger than the reference time (e.g., within about +2 hours of the error range) set in advance in the electronic device, the electronic device may display the third administration notification 944, and output a sound and a vibration from the electronic device.

According to various embodiments, when displaying the administration notifications 940, 942, and 944 associated with the medicine which the user must take, the electronic device may use a motion sensor or an optical sensor, which is functionally connected to the electronic device. For example, in order to determine whether the corresponding medicine is administered in relation to the administration notifications 940, 942, and 944, the electronic device may detect an administration movement of the user or an image of the medicine using the motion sensor or the optical sensor. In addition, in order to determine whether the corresponding medicine is administered, the electronic device may use the PPG sensor or the ECG sensor. The electronic device may determine the elasticity of blood vessels to determine whether a heart medicine is administered using, for example, accelerated plethysmograph (APG) information acquired through the PPG sensor or the ECG sensor. For example, when the error of the medication time of the user is larger than or significantly larger than the reference value (threshold) set in advance in the electronic device, the electronic device may determine the elasticity of blood vessels of the user. According to an embodiment, when the elasticity of blood vessels is lower than a reference value set in advance in the electronic device, the electronic device may display the administration notifications 940, 942, and 944 associated with the medicine which the user must take.

According to various embodiments, the electronic device may change a period of the administration notifications 940, 942, and 944 displayed on the display. For example, when the medication time of the user is close (e.g., within about ±30 minutes) to a time (e.g., 9 a.m., 1 p.m. or 5 p.m., or the like) set in advance in the electronic device, the electronic device may change the acquisition period of the biometric information to be shorter than a reference value (e.g., 10 times/one hour). In addition, for example, when the medication of the user is determined, the electronic device may change the acquisition period of the biometric information to be longer (e.g., 5 times/one hour) than the reference value (e.g., 10 times/one hour).

According to various embodiments, the electronic device may display the exercise notification 950 and/or the recommendation notifications 954 and 956 using the sleep notifications 920 and 930 and/or the administration notifications 940, 942, and 944. For example, the electronic device may display the exercise notification 950 indicating an exercise required for the user and/or the recommendation notifications 954 and 956 indicating information recommended to the user, using the sleep notifications 920 and 930 indicating the user's sleep state and/or the administration notifications 940, 942, and 944 associated with the medicine which the user must take. The electronic device may display an icon and/or an image indicating a type of an exercise (e.g., walking (steps), running, swimming, tennis, or the like) as the exercise notification 950 required for the user, based on, for example, the sleep state (e.g., the sleep time) and/or the medication time. In addition, the recommendation notifications 954 and 956 may indicate an exercise time (e.g., about one or two hours) required for the user and/or an exercise environment (e.g., the indoor or the outdoor) or media (e.g., music or image) associated with the exercise required for the user, based on, for example, the sleep state (e.g., the sleep time) and/or the medication time.

According to various embodiments, the electronic device may execute the application 960 (e.g., the media player 382 of FIG. 3) associated with the exercise notification 950, the weather notifications 932 and 952, or the recommendation notifications 954 and 956 while the exercise notification 950, the weather notifications 932 and 952, or the recommendation notifications 954 and 956 are displayed on the display. For example, the electronic device may automatically execute the application 960 capable of determining or executing the media while displaying (playing) the media associated with the exercise required for the user as the recommendation notifications 954 and 956. In addition, an execution screen of the application 960 may be displayed on the display, simultaneously or sequentially with, for example, the exercise notification 950, the weather notifications 932 and 952, or the recommendation notifications 954 and 956.

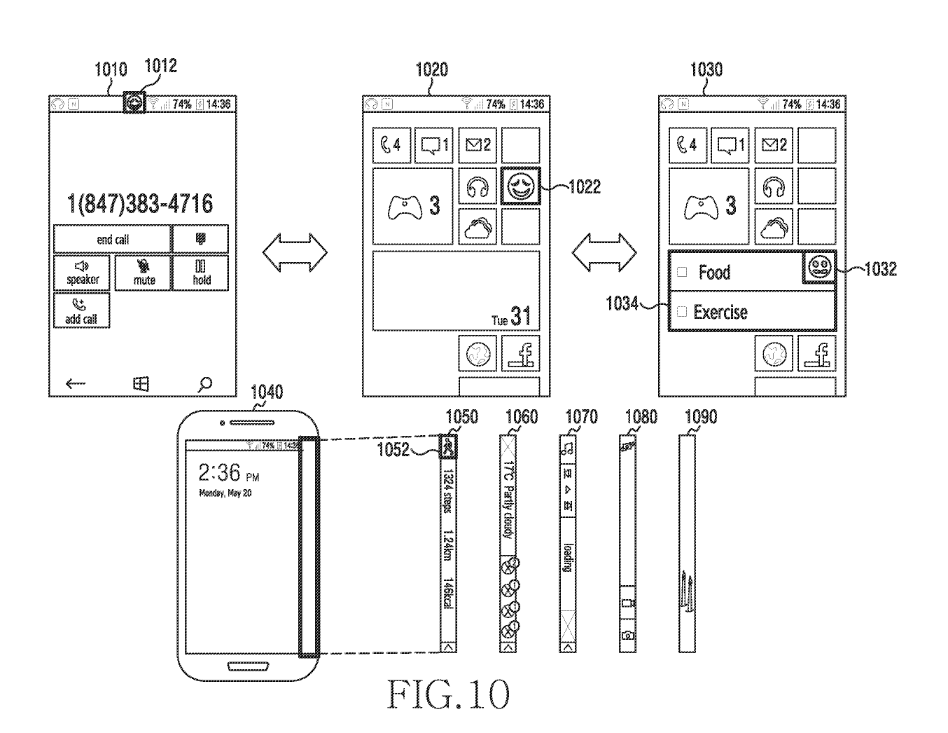

FIG. 10 illustrates an example in which a user interface for providing a notification corresponding to user biometric information and/or a notification indicating an application associated with the user biometric information is applied in an electronic device according to various embodiments of the present disclosure.

Referring to FIG. 10, the electronic device (e.g., the electronic device 101) may display, for example, notification display user interfaces 1010, 1020, 1030, and 1040 in at least a part of a display (e.g., the display 160 of FIG. 1) functionally connected to the electronic device. The notification display user interfaces 1010, 1020, 1030, and 1040 may include, for example, at least one of biometric information notifications 1012, 1022, 1032, and 1052, biometric information additional notification 1034, and application notifications 1050, 1060, 1070, 1080, and 1090. The biometric information notifications may include, for example, at least one of the first biometric information notification 1012, the second biometric information notification 1022, the third biometric information notification 1032, and the fourth biometric information notification 1052.

According to various embodiments, the electronic device may display at least one of the biometric information notifications 1012, 1022, 1032, and 1052, the biometric information additional notification 1034, and application notifications 1050, 1060, 1070, 1080, and 1090, through the notification display user interfaces 1010, 1020, 1030, and 1040, and the notification display user interfaces 1010, 1020, 1030, and 1040 may be included in at least a part of the display. For example, the notification display user interfaces 1010, 1020, 1030, and 1040 may be displayed in at least partial region of at least one of a notification bar, a state bar, a task bar, a home screen, a lock screen, and a bended display, and the types of the notification display user interfaces 1010, 1020, 1030, and 1040 may be displayed as at least one of icons, floating icons, and tiles.

According to various embodiments, the electronic device may change the regions (e.g., the notification bar, the state bar, the task bar, the home screen, the lock screen, the bended display, etc.) and/or the types (e.g., the icons, the floating icons, the tiles, etc.) of the biometric information notifications 1012, 1022, 1032, and 1052, the biometric information additional notification 1034, or the application notifications 1050, 1060, 1070, 1080, and 1090, which are displayed through the notification display user interfaces 1010, 1020, 1030, and 1040. For example, the electronic device may change the first biometric information notification 1012 displayed in the notification display user interface 1010 to the second biometric information notification 1022 displayed in the notification display user interface 1020. In addition, when the first biometric information notification 1012 is changed to the second biometric information notification 1022, the region and/or the type of the notification display user interface 1010 may be changed. The electronic device may display, for example, the first biometric information notification 1012 using the region of at least one of the notification bar, the state bar, and the task bar, and the icon and/or the image, and display the second biometric information notification 1022 using the home screen region and the tiles.

According to various embodiments, the electronic device may change the region in which the biometric information notifications 1012, 1022, and 1032 and/or the biometric information additional notification 1034 are displayed and/or the type while the biometric information notifications 1012, 1022, 1032, and 1052 and/or the biometric information additional notification 1034 are simultaneously or sequentially displayed. For example, the electronic device may additionally display the third biometric information notification 1032 or the biometric information additional notification 1034 associated with the biometric information of the user in the notification display user interface 1030 while changing the second biometric information notification 1022 to the third biometric information notification 1032. The biometric information additional notification 1034 may include, for example, the third biometric information notification 1032 or a recommendation associated with the biometric information of the user. The recommendation may include foods, exercises, and locations (places) associated with the biometric information of the user or an application associated with the user biometric information.

According to various embodiments, the electronic device may display the application notifications 1050, 1060, 1070, 1080, and 1090 in at least a partial region of the notification display user interface 1040, and the at least a partial region may include a region (e.g., a bended display) capable of providing additional information to the user in the electronic device. For example, the electronic device may simultaneously or sequentially display the biometric information notifications 1012, 1022, 1032, and 1052 and/or the biometric information additional notification 1034 in the notification display user interface 1040 while displaying the application notifications 1050, 1060, 1070, 1080, and 1090 in the bended display region. The application notifications 1050, 1060, 1070, 1080, and 1090 may include, for example, at least one of the health application 1050, the schedule application 1060, the music application 1070, the camera application 1080, and the media application 1090.

According to various embodiments, when a movement state (e.g., exercise) or a degree of tension (e.g., a stress state) among condition information of the user is included in a predefined condition, the electronic device may display the application notifications 1050, 1060, 1070, 1080, and 1090 on the display (e.g., the bended display). For example, when the movement state is a running state and included in the predefined condition, the electronic device may display at least one of the health application 1050 and the music application 1070 among the application notifications 1050, 1060, 1070, 1080, and 1090 in at least a partial region of the bended display. In addition, when the degree of tension (e.g., the stress state) is higher (e.g., the degree of tension of 5 or higher/maximum value of 10) than a value set in advance in the electronic device, the electronic device may display at least one of the music application 1070, the camera application 1080, and the media application 1090 in at least a partial region of the bended display. The electronic device may display at least one of, for example, the music application 1070, the camera application 1080, and the media application 1090 in at least a partial region of the bended display, and thereby reduce the degree of tension of the user. The camera application 1080 may photograph or record a condition in which a change in the degree of tension of the user is acquired, and the media application 1090 may display a picture or a video (e.g., candle image or breathing guide) capable of reducing the degree of tension of the user.

According to various embodiments, the electronic device may display the biometric information notifications 1012, 1022, 1032, and 1052 and the application notifications 1050, 1060, 1070, 1080, and 1090 in at least a part of the notification display user interface 1040. For example, the electronic device may simultaneously or sequentially display the biometric information notifications 1012, 1022, 1032, and 1052 and the application notifications 1050, 1060, 1070, 1080, and 1090 in the notification display user interface 1040. The electronic device may display the application notifications 1050, 1060, 1070, 1080, and 1090 simultaneously or sequentially with the biometric information notifications 1012, 1022, 1032, and 1052 based on a user input or a predefined condition or feedback information included in the electronic device, while displaying the biometric information notifications 1012, 1022, 1032, and 1052 in the at least a part of the notification display user interface 1040. The biometric information notifications 1012, 1022, 1032, and 1052 may have sizes smaller than or equal to those of the application notifications 1050, 1060, 1070, 1080, and 1090.

According to various embodiments, the electronic device may additionally change the notification display user interfaces 1010, 1020, 1030, and 1040 based on the predefined condition or the feedback information. For example, the electronic device may additionally display at least one of a text, an image, an icon, and a widget which are not displayed in the notification display user interfaces 1010, 1020, 1030, and 1040, hide the at least one from the user's field of vision, or delete the at least one from the notification display user interfaces 1010, 1020, 1030, and 1040.

According to various embodiments, electronic device may display the biometric information notifications 1012, 1022, 1032, and 1052, the biometric information additional notification 1034, or the application notifications 1050, 1060, 1070, 1080, and 1090, which are displayed through the notification display user interfaces 1010, 1020, 1030, and 1040, simultaneously or sequentially with a residual quantity of a battery or an received signal strength indication (RSSI) of an antenna, which is displayed on the display. For example, the electronic device may simultaneously or sequentially display the biometric information notifications 1012, 1022, 1032, and 1052, the biometric information additional notification 1034, or the application notifications 1050, 1060, 1070, 1080, and 1090 in the region (e.g., the notification bar) indicating the residual quantity of the battery or the RSSI of the antenna.

According to various embodiments, the electronic device may change information displayed in the notification display user interfaces 1010, 1020, 1030, and 1040. For example, when a full screen mode (e.g., a video player mode) is executed through the display, the electronic device may not display at least a part of the biometric information notifications 1012, 1022, 1032, and 1052, and the biometric information additional notification 1034. For example, the electronic device may further include an operation for displaying at least one of the biometric information notifications 1012, 1022, 1032, 1034, and 1052 and the biometric information additional notification 1034 so as to have a different type (e.g., the floating icons, the application notifications 1050, 1060, 1070, 1080, and 1090, or the tiles).

FIG. 11A is a flowchart illustrating a method for executing an application associated with user biometric information in an electronic device according to various embodiments of the present disclosure.

Referring to FIG. 11A, in operation 1110, the electronic device (e.g., the condition analysis module 180 of FIG. 1) may acquire biometric information associated with a user from a sensor module (e.g., the sensor modules 560 and 562 of FIG. 5) functionally connected to, for example, the electronic device and/or an external device (e.g., the first external electronic device 102, the second external electronic device 104, or the server 106 of FIG. 1).

In operation 1120, the electronic device (e.g., the condition analysis module 180 of FIG. 1) may determine, for example, condition information associated with the user based on biometric information associated with at least the user.

In operation 1130, the electronic device (e.g., the condition analysis module 180 of FIG. 1) may compare the determined condition information with information (e.g., a predefined condition or feedback information) stored in a predefined condition database (e.g., the predefined condition database 570 of FIG. 5) and/or a memory (e.g., the memory 580 of FIG. 5), which is included in the electronic device, and determine whether the determined condition information is included in the predefined condition and/or the feedback information.

According to an embodiment, in operation 1130, the electronic device may compare the determined condition information with the predefined condition and/or the feedback information, and determine whether the determined condition information is included in the predefined condition and/or the feedback information. The predefined condition and/or the feedback information may include at least one of, for example, a priority of the condition information, a validity period, a criterion for acquiring the biometric information, a method of combining a plurality of pieces of biometric information and/or condition information, and a criterion for acquiring additional biometric information based on the condition information.

When it is determined that the determined condition information is not included in the predefined condition and/or the feedback information in operation 1130, the electronic device (e.g., the condition analysis module 180 of FIG. 1) may perform, for example, operation 1140.

According to an embodiment, in operation 1140, the electronic device may display a notification corresponding to the biometric information in a display functionally connected to the electronic device.

In operation 1150, the electronic device (e.g., the condition analysis module 180 of FIG. 1) may determine, for example, whether a user input (e.g., a request or selection) or an external input (e.g., an input from an external device) occurs. According to an embodiment, in operation 1150, the electronic device may determine whether the user input occurs using a user interface displayed through the display. In addition, in operation 1150, the electronic device may determine whether the same or similar external input as or to the user input occurs from the external device (e.g., the first external electronic device 102, the second external electronic device 104, or the server 106 of FIG. 1).

When it is determined that the user input or the external input does not occur in operation 1150, the electronic device (e.g., the condition analysis module 180 of FIG. 1) may perform, for example, operation 1110 again.

When it is determined that the user input or the external input occurs in operation 1150, the electronic device (e.g., the condition analysis module 180 of FIG. 1) may perform, for example, operation 1160.

When it is determined that the determined condition information is included in the predefined condition and/or the feedback information in operation 1130, the electronic device (e.g., the condition analysis module 180 of FIG. 1) may perform, for example, operation 1160.

According to an embodiment, in operation 1160, the electronic device may perform authentication associated with the user. In addition, the electronic device may immediately perform operation 1170 without performing operation 1160, based on a state of the electronic device (e.g., a power saving mode), a location of the electronic device, whether the authentication has been previously performed, or the user input. In addition, the electronic device may automatically or manually perform authentication associated with the user based on at least one of the biometric information, the condition information, the predefined condition, and the feedback information. According to an embodiment, the electronic device may automatically or manually perform operation 1160 based on the determination of operation 1150.

When it is determined that the determined condition information is included in the predefined condition and/or the feedback information in operation 1130 or after operation 1160 is performed, the electronic device (e.g., the condition analysis module 180 of FIG. 1) may perform, for example, operation 1170.

According to an embodiment, in operation 1170, the electronic device may automatically execute an application associated with the biometric information.

FIG. 11B illustrates an example in which a user interface for providing information through a notification corresponding to user biometric information, a notification display user interface, and/or an application associated with the user biometric information in an electronic device according to various embodiments of the present disclosure.

Referring to FIG. 11B, the electronic device (e.g., the electronic device 101) may display, for example, a notification display user interface 1184 and/or application user interfaces 1170, 1180, and 1190 through a display (e.g., the display 160 of FIG. 1) functionally connected to the electronic device. The notification display user interface 1184 may include, for example, a notification 1182 corresponding to user biometric information. In addition, the application user interfaces 1170, 1180, and 1190 may include the first application user interface 1170, the second application user interface 1180, or the third application user interface 1190. In addition, each of the application user interfaces 1170, 1180, and 1190 may include, for example, a plurality of pieces of information 1192, 1194, and 1196 provided through the application (e.g., the health application 492 of FIG. 4) associated with the user biometric information. The plurality of pieces of information 1192, 1194, and 1196 provided through the application associated with the user biometric information may include, for example, basic information 1192 and/or detailed information 1194 and 1196, and the detailed information 1194 and 1196 may include the first detailed information 1194 or the second detailed information 1196. The basic information 1192 may include, for example, summary information associated with the user biometric information, and the detailed information 1194 and 1196 may include a variety of information associated with the user biometric information, for example, a larger amount of information than that of the summary information. The notification 1182 corresponding to the user biometric information may be referred to as a biometric information notification 1182, for convenience of description.

According to various embodiments, the electronic device may change the information displayed on the display based on whether the user biometric information is acquired. For example, when the user biometric information is acquired, the electronic device may change the first application user interface 1170 to the second application user interface 1180. The first application user interface 1170 may display information (e.g., time) which is not associated with the user biometric information, and the second application user interface 1180 may display a notification (e.g., the connection notification 732, the installation (wear) notification 752, the biometric information notification 772, the movement (motion) notification 792, or the emotional state notification (not shown)) corresponding to the user biometric information. In addition, the electronic device may set, for example, the first application user interface 1170 to a general mode, and the second application user interface 1180 to a health mode. The electronic device may display, for example, a lock screen in the general mode, and simultaneously or sequentially display the lock screen and the user biometric information in the health mode.

According to various embodiments, the electronic device may display the biometric information notification 1182 and/or the notification display user interface 1184 in the second application user interface 1180. For example, the electronic device may display the biometric information notification 1182 and/or the notification display user interface 1184 in at least a part of the second application user interface 1180, and display the biometric information notification 1182 and/or the notification display user interface 1184 simultaneously with the lock screen displayed in the second application user interface 1180. In addition, the notification display user interface 1184 may include a plurality of biometric information notifications 1182.

According to various embodiments, the electronic device may display the basic information 1192 and/or the detailed information 1194 and 1196 which are provided through the application associated with the user biometric information in the third application user interface 1190. For example, the electronic device may display the basic information 1192 and/or the detailed information 1194 and 1196 in at least a part of the third application user interface 1190, and display the basic information 1192 and/or the detailed information 1194 and 1196 simultaneously or sequentially with the notification display user interface 1184 displayed in the second application user interface 1180.

According to various embodiments, the electronic device may display the basic information 1192 and/or the detailed information 1194 and 1196 which are provided through the application associated with the user biometric information, based on user authentication. For example, when the user authentication is not performed (e.g., when the user authentication does not succeed), the electronic device may display the first or second application user interface 1170 or 1180, or provide the basic information 1192 associated with the user biometric information through the application associated with the user biometric information. For example, in the electronic device, the basic information 1192 associated with the user biometric information may include information (e.g., the number of steps of today, a currently measured heart rate or blood pressure) that does not require user authentication. In addition, when the user authentication is performed (e.g., when the user authentication succeeds), the electronic device may provide the detailed information 1194 and 1196 associated with the user biometric information through the application associated with the user biometric information.

According to various embodiments, the electronic device may provide personalized information (e.g., preferred media, set exercise goal, exercise friend contact history, or recommended foods) associated with the user based on the user authentication, the biometric information associated with the user, and/or the condition information. For example, when the user authentication succeeds, the electronic device may store the biometric information associated with the user and/or the condition information in the electronic device or the external device (e.g., the first external electronic device 102, the second external electronic device 104, or the server 106 of FIG. 1). In addition, the electronic device may perform machine running based on the stored biometric information and/or condition information, and provide personalized services associated with the user through the machine running. In addition, the electronic device may visually provide history information associated with the personalized services according to a predefined criterion (e.g., date or time).

In addition, when the user authentication is not performed or does not succeed, the electronic device may not provide the personalized services associated with the user. For example, when the user authentication is not performed or does not succeed, the electronic device may change (e.g., change the mode to a guest mode) the mode of the electronic device, and does not provide the personalized services. In addition, when the mode of the electronic device is the guest mode, or when the user authentication succeeds in the electronic device, the electronic device may add or change (e.g., update) the acquired biometric information and/or condition information associated with the user to the history information associated with the personalized services. In addition, in order to add or change the biometric information and/or the condition information to the history information associated with the personalized services, the electronic device may provide an additional user interface. The additional user interface (e.g., a pop-up window or an update button of an application) may include a button for selecting whether to include the history information, a type of the biometric information, an acquisition time, or an acquisition range.

According to various embodiments, the electronic device may change conditions to store the biometric information and/or the condition information in the electronic device or the external device. The electronic device may provide, for example, a user interface (e.g., fingerprint recognition, iris recognition, voice speaker recognition, a password input, a pattern lock interface, or the like) for performing the user authentication, and detect an installation (wear) state (e.g., the installation (wear) state 750 of FIG. 7) of the electronic device after the user authentication succeeds through the user interface. In addition, the electronic device may be, for example, a device (e.g., a wearable device) that can be attached to the body, and the user authentication may be automatically performed in the electronic device when the installation of the electronic device is detected (e.g., the installation (wear) state 750 of FIG. 7). When the installation of the electronic device in the body is detected or when the user authentication is performed (e.g., log-in or log-out) through the user interface for performing the user authentication, the electronic device may store the biometric information associated with the user in the electronic device or the external device. In addition, the electronic device may provide, for example, the personalized services associated with the user using the biometric information stored in the electronic device or the external device.

According to various embodiments, the electronic device may change information displayed in the detailed information 1194 and 1196 depending on a user authentication method (e.g., password, fingerprint, voice, or iris recognition). For example, when the complexity of the user authentication is relatively low or when information used in the authentication is changed by the corresponding user or other users (e.g., password, fingerprint, or pattern recognition), the electronic device, the electronic device may provide the first detailed information 1194 out of the detailed information 1194 and 1196. In addition, when the complexity of the user authentication is relatively high or when the information used in the authentication is not changed by the corresponding user or other users (e.g., iris recognition), the electronic device, the electronic device may provide the second detailed information 1196 out of the detailed information 1194 and 1196. The complexity may be changed based on the number of pieces or length of information used in the user authentication. The first detailed information 1194 may include a history associated with the user biometric information and personal information of the user (e.g., a calendar schedule, a medication, a surgical history, a height, an age, a body weight, etc.), and the second detailed information 1196 may include a recommendation associated with the user biometric information.

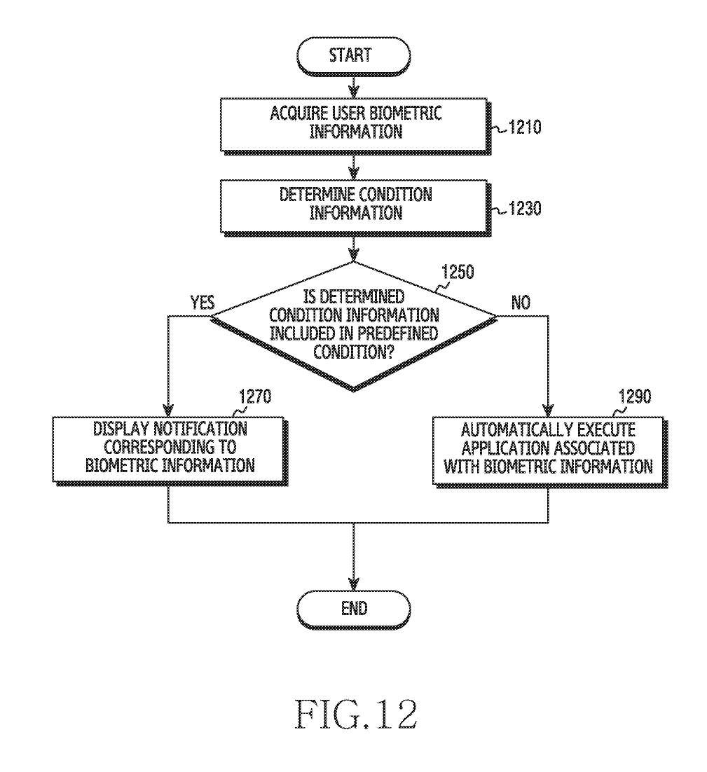

FIG. 12 is a flowchart illustrating a method for executing a notification corresponding to user biometric information or an application associated with the user biometric information using a condition analysis module in an electronic device according to various embodiments of the present disclosure.

According to an embodiment, user biometric information may include information associated with a health state, an emotional state, or an active state of a user.

According to an embodiment, the biometric information may include state information of the electronic device of the user or another external device for measuring the biometric information.

Referring to FIG. 12, in operation 1210, the electronic device (e.g., the condition analysis module 180 of FIG. 1) may acquire biometric information associated with the user from a sensor module (e.g., the sensor modules 560 and 562 of FIG. 5) functionally connected to, for example, the electronic device and/or the external device.

In operation 1230, the electronic device (e.g., the condition analysis module 180 of FIG. 1) may determine, for example, condition information associated with the user based on at least the biometric information.

In operation 1250, the electronic device (e.g., the condition analysis module 180 of FIG. 1) may compare the determined condition information with information (e.g., a predefined condition or feedback information) stored in a predefined condition database (e.g., the predefined condition database 570 of FIG. 5) and/or a memory (e.g., the memory 580 of FIG. 5), which is included in the electronic device, and determine whether the determined condition information is included in the predefined condition and/or the feedback information. According to an embodiment, in operation 1250, the electronic device may compare or determine whether the determined condition information is included in a first predefined condition or a second predefined condition, using at least one of the predefined condition and the feedback information.

When the condition information corresponds to the first predefined condition based on the comparison or determination results in operation 1250, the electronic device (e.g., the condition analysis module 180 of FIG. 1) may perform, for example, operation 1270.

According to an embodiment, in operation 1270, the electronic device may display a notification corresponding to the biometric information through a display functionally connected to the electronic device.

When the condition information corresponds to the second predefined condition based on the comparison or determination results in operation 1250, the electronic device (e.g., the condition analysis module 180 of FIG. 1) may perform, for example, operation 1290.

According to an embodiment, in operation 1290, the electronic device may automatically execute the application associated with the biometric information.

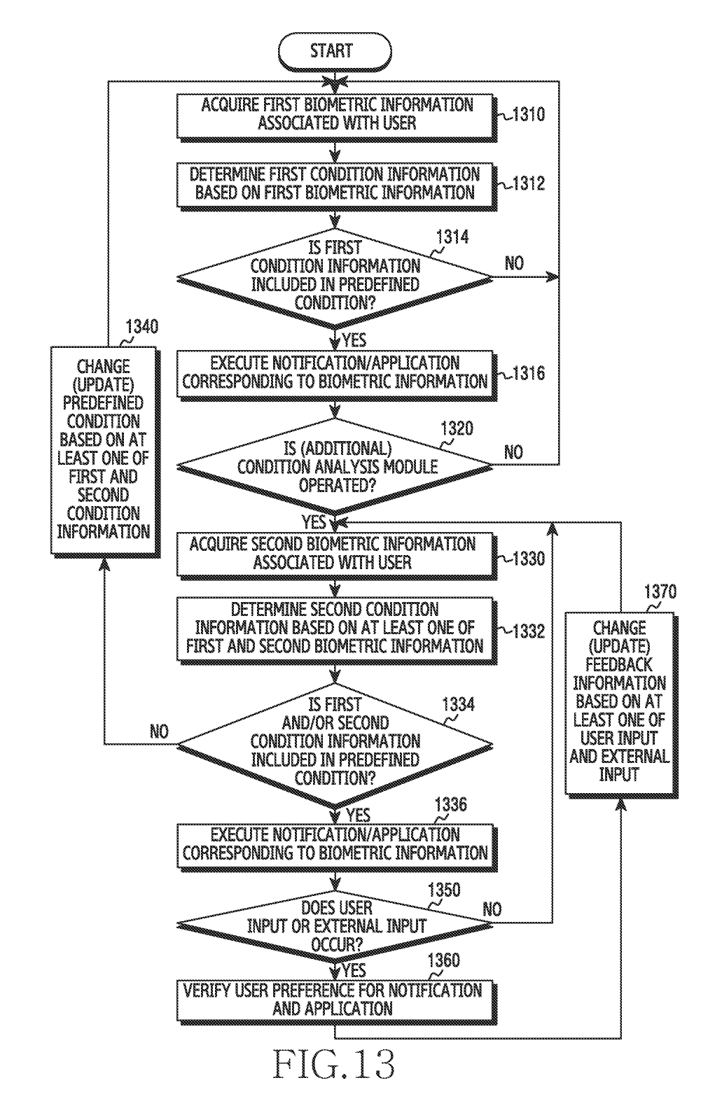

FIG. 13 is a flowchart illustrating a method for executing a notification corresponding to user biometric information and/or an application associated with the user biometric information, and for changing a predefined condition and/or feedback information in an electronic device according to various embodiments of the present disclosure.

Referring to FIG. 13, in operation 1310, the electronic device (e.g., the condition analysis module 180 of FIG. 1) may acquire first biometric information associated with a user from a sensor module (e.g., the sensor modules 560 and 562 of FIG. 5) functionally connected to, for example, the electronic device and/or the external device.

In operation 1312, the electronic device (e.g., the condition analysis module 180 of FIG. 1) may determine first condition information associated with the user based on at least the first biometric information associated with the user, for example, in a first condition analysis module included in the electronic device.

In operation 1314, the electronic device (e.g., the condition analysis module 180 of FIG. 1) may compare the first condition information with information (e.g., a predefined condition or feedback information) stored in a predefined condition database (e.g., the predefined condition database 570 of FIG. 5) and/or a memory (e.g., the memory 580 of FIG. 5), which is included in the electronic device, and determine whether the first condition information is included in the predefined condition and/or the feedback information.

According to an embodiment, the first condition analysis module may compare and determine whether the condition information is included in the predefined condition and/or the feedback information.

When the condition information is included in the predefined condition and/or the feedback information based on the comparison or determination results in operation 1314, the electronic device (e.g., the condition analysis module 180 of FIG. 1) may perform, for example, operation 1316.

According to an embodiment, in operation 1316, the electronic device may display a notification corresponding to the biometric information through the display functionally connected to the electronic device, or automatically execute an application associated with the biometric information.

When the condition information is not included in the predefined condition and/or the feedback information based on the comparison or determination results in operation 1314, the electronic device (e.g., the condition analysis module 180 of FIG. 1) may perform, for example, operation 1310 again.

In operation 1320, the electronic device (e.g., the condition analysis module 180 of FIG. 1) may determine whether a second condition analysis module included in the electronic device is operated, for example, in the first condition analysis module.

According to an embodiment, in operation 1320, the first condition analysis module may determine whether the second condition analysis module is operated based on the predefined condition and/or the feedback information.

When the second condition analysis module is operated based on the determination result in operation 1320, the electronic device (e.g., the condition analysis module 180 of FIG. 1) may perform, for example, operation 1330. According to an embodiment, in operation 1330, the electronic device may acquire second biometric information associated with the user.

According to an embodiment, the electronic device may use the predefined condition and/or the feedback information as the second biometric information. For example, the electronic device may acquire the second biometric information using condition information (e.g., (health) application information, user personal information, health information, user exercise information, preferred media, exercise friend contacts, administration information, recommended contents, weather, temperature, humidity, calendar schedule, food information, location information, or the like) stored in the electronic device or the external device (e.g., the first external electronic device 102, the second external electronic device 104, or the server 106 of FIG. 1).

When the second condition analysis module is not operated based on the determination result in operation 1320, the electronic device (e.g., the electronic device 101) may perform, for example, operation 1310 again.

In operation 1332, the electronic device (e.g., the electronic device 101) may determine second condition information associated with the user based on at least one of the first biometric information and the second biometric information, for example, in the second condition analysis module.

In operation 1334, the electronic device (e.g., the electronic device 101) may compare the first condition information and/or the second condition information with information (e.g., a predefined condition or feedback information) stored in the predefined condition database (e.g., the predefined condition database 570 of FIG. 5) and/or the memory (e.g., the memory 580 of FIG. 5), which is included in the electronic device, in the second condition analysis module, and determine whether the first condition information and/or the second condition information is included in the predefined condition and/or the feedback information.

According to an embodiment, in operation 1334, the second condition analysis module may compare or determine whether the first condition information and/or the second condition information is included in the predefined condition and/or the feedback information.

When the first condition information and/or the second condition information is included in the predefined condition and/or the feedback information based on the comparison or determination result in operation 1334, the electronic device (e.g., the condition analysis module 180 of FIG. 1) may perform, for example, operation 1336.

According to an embodiment, in operation 1336, the electronic device may display the notification corresponding to the biometric information through the display functionally connected to the electronic device, or automatically execute the application associated with the biometric information.

When the first condition information and/or the second condition information is not included in the predefined condition and/or the feedback information based on the comparison or determination result in operation 1334, the electronic device (e.g., the condition analysis module 180 of FIG. 1) may perform, for example, operation 1340.

According to an embodiment, in operation 1340, the electronic device may change the predefined condition used by the first condition analysis module and/or the second condition analysis module, based on at least one of the first condition information determined in operation 1312 and the second condition information determined in operation 1332. Thereafter, the electronic device may perform operation 1310 again.

In operation 1350, the electronic device (e.g., the condition analysis module 180 of FIG. 1) may determine, for example, whether a user input (e.g., a request or selection) or an external input (e.g., an input from an external device) occurs. According to an embodiment, in operation 1350, the electronic device may determine whether the user input occurs using a user interface displayed through the display. In addition, the electronic device may determine whether the same or similar external input as or to the user input occurs from the external device (e.g., the first external electronic device 102, the second external electronic device 104, or the server 106 of FIG. 1).

When the user input or the external input occurs based on the determination result in operation 1350, the electronic device (e.g., the condition analysis module 180 of FIG. 1) may perform, for example, operation 1360.

According to an embodiment, in operation 1360, the electronic device may perform the verification of the notification corresponding to the biometric information or the application associated with the biometric information, which has been performed in operation 1316 or operation 1336, based on the user input or the external input. The verification may include preference (e.g., priority) of the user with respect to the notification corresponding to the biometric information or the application associated with the biometric information.

When the user input or the external input does not occur based on the determination result in operation 1350, the electronic device (e.g., the condition analysis module 180 of FIG. 1) may perform, for example, operation 1330 again.

In operation 1370, the electronic device (e.g., the condition analysis module 180 of FIG. 1) may change the feedback information used by the first condition analysis module and/or the second condition analysis module, based on at least one of the user input and the external input of operation 1360. Thereafter, the electronic device (e.g., the condition analysis module 180 of FIG. 1) may perform operation 1330 again.

The operations (e.g., operations 410 to 490, operations 1110 to 1170, operations 1210 to 1290, and operations 1310 to 1370) described in the process and method illustrated in FIG. 4 and FIGS. 11 to 13 may be performed in a sequential, parallel, repetitive, or heuristic method. For example, the operations may be performed in a different order, some operations may be omitted, or other operations may be added.

According to an embodiment, the electronic device may automatically execute the application associated with the biometric information while displaying the notification corresponding to the biometric information associated with the user through the display functionally connected to the electronic device. For example, the electronic device may simultaneously or sequentially display the notification and/or the application on the display, and change the displayed region and/or type.

According to various embodiments, a method for displaying a user interface in an electronic device may include obtaining biometric information associated with a user of the electronic device from the electronic device, determining condition information associated with the user based on at least the biometric information; displaying a notification corresponding to the biometric information via a display functionally connected to the electronic device when the condition information corresponds to a first predefined condition, and automatically executing an application associated with the biometric information when the condition information corresponds to a second predefined condition.

According to various embodiments, the determining may include determining at least one of a sleep state, a motion state, a health state, and an emotional state of the user as at least a part of the condition, based on at least the biometric information.

According to various embodiments, the determining may include transmitting the condition information or a representation corresponding to the condition information to an external device of the electronic device.

According to various embodiments, the displaying may include refraining from automatically executing the application.

According to various embodiments, the displaying may include changing at least a part of the notification based on the biometric information.

According to various embodiments, the automatically executing may include at least one of providing a recommendation associated with the biometric information to the user, or automatically releasing a lock screen on the electronic device.

According to various embodiments, the automatically executing may include executing authentication for the user based on at least the biometric information.

According to various embodiments, the providing of the recommendation may include determining the recommendation further based on other biometric information associated with the user or condition information associated with the electronic device.

According to various embodiments, the providing of the recommendation may be performed when the condition information corresponds to a third predefined condition.

According to various embodiments, the providing of the recommendation may include selecting, as the recommendation, a recommendation for at least one of a place associated with the biometric information, media or sports preferred by the user, and an action that is required to be taken by the user.

The electronic device and method according to various embodiments may change a user interface based on, for example, biometric information associated with a user or determine information to be displayed, and therefore it is possible to efficiently use services provided from the electronic device. In addition, a user interface provided according to personal information (e.g., a health state or the like) or region information (e.g., a place or time) may be changed, and therefore it is possible to provide personalized services. In addition, the electronic device may share the biometric information and condition information associated with the biometric information through a communication connection between one or more electronic devices, and display the notification corresponding to the biometric information or execute the application associated with the biometric information, and therefore it is possible to obtain desired information of the user and perform a desired function, and to improve the utilization of the electronic device.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a read only memory (ROM), a random access memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

According to various embodiments, in a recording medium that stores instructions, the instructions may be set to enable one or more processors to execute one or more operations when being executed by the one or more processors. Here, the one or more operations may include an operation for obtaining, from an electronic device, biometric information associated with a user of the electronic device, an operation for determining condition information associated with the user based on at least the biometric information, an operation for displaying a notification corresponding to the biometric information via a display functionally connected to the electronic device when the condition information corresponds to a first predefined condition, and an operation for automatically executing an application associated with the biometric information when the condition information corresponds to a second predefined condition.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Further, the embodiments disclosed in this document are only for the description and understanding of technical contents and do not limit the scope of the present disclosure. Accordingly, the scope of the present disclosure should be construed as including all modifications or various other embodiments based on the technical idea of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
obtaining biometric information associated with a user of the electronic device from the electronic device;
determining condition information associated with the user based on the biometric information;
displaying a notification corresponding to the biometric information when the condition information corresponds to a first predefined condition; and
automatically executing an application associated with the biometric information when the condition information corresponds to a second predefined condition.

2. The method of claim 1, wherein the determining the condition information comprises determining at least one of a sleep state, a motion state, a health state, or an emotional state of the user as at least a part of the condition, based on the biometric information.

3. The method of claim 1, further comprising transmitting the condition information to an external device of the electronic device.

4. The method of claim 1, further comprising refraining from automatically executing the application associated with the biometric information when the notification corresponding to the biometric information is displayed.

5. The method of claim 1, wherein the displaying the notification corresponding to the biometric information comprises changing at least a part of the notification based on the biometric information.

6. The method of claim 1, wherein the automatically executing the application associated with the biometric information comprises at least one of providing recommendation information associated with the biometric information to the user, or automatically releasing a lock screen on the electronic device.

7. The method of claim 6, wherein the providing of the recommendation information comprises determining the recommendation information further based on other biometric information associated with the user or condition information associated with the user.

8. The method of claim 6, wherein the providing of the recommendation information is performed when the condition information corresponds to a third predefined condition.

9. The method of claim 6, wherein the recommendation includes at least one of a place associated with the biometric information, media preferred by the user, sports preferred by the user, or an action that is required to be taken by the user.

10. The method of claim 1, wherein the automatically executing includes executing authentication for the user based on the biometric information.

11. An electronic device comprising:
a display functionally connected to the electronic device;
a sensor configured to receive information associated with at least one of a user and an ambient environment from the outside; and
a processor-implemented condition analysis module that is functionally connected to the sensor,
wherein the condition analysis module is configured to:
obtain biometric information associated with the user of the electronic device,
determine condition information associated with the user based on the biometric information,
control the display to display a notification corresponding to the biometric information when the condition information corresponds to a first predefined condition, and
automatically execute an application associated with the biometric information when the condition information corresponds to a second predefined condition.

12. The electronic device of claim 11, wherein the condition analysis module is further configured to obtain the biometric information associated with the user through the processor corresponding to a low power module functionally connected to the electronic device.

13. The electronic device of claim 11, wherein the condition analysis module is further configured to determine at least one of a sleep state, a motion state, a health state, and an emotional state of the user as at least a part of the condition, based on the biometric information.

14. The electronic device of claim 11, wherein the condition analysis module is further configured to change at least a part of the notification based on the biometric information.

15. The electronic device of claim 14, wherein the condition analysis module is further configured to change a scheme in which the corresponding data is output from the electronic device associated with the notification to the outside, a color, a luminosity, a transparency, a display position, a size, a content displayed in the at least a part of the notification, or a visual effect of the content, based on at least the condition.

16. The electronic device of claim 11, wherein the condition analysis module is further configured to execute authentication for the user based on the biometric information.

17. The electronic device of claim 16, wherein the condition analysis module is further configured to adjust recommendation information provided to the user, based on at least one of the authentication for the user and a connection state between the electronic device and an external device.

18. The electronic device of claim 11, wherein the condition analysis module is further configured to determine whether to obtain one or more pieces of at least one of additional or new condition information based on the condition information.

19. The electronic device of claim 11, wherein the condition analysis module is further configured to change the predefined condition based on at least one of the condition information and a user's input.

20. A non-transient computer-readable recording medium that stores a program for executing:
an operation for obtaining, from an electronic device, biometric information associated with a user of the electronic device,
an operation for determining condition information associated with the user based on the biometric information,
an operation for displaying a notification corresponding to the biometric information via a display functionally connected to the electronic device when the condition information corresponds to a first predefined condition; and
an operation for automatically executing an application associated with the biometric information when the condition information corresponds to a second predefined condition.
